(19) United States
(12) Patent Application Publication
(10) Pub. No.: US 2024/0345208 A1
(43) Pub. Date: Oct. 17, 2024

(54) SYSTEMS AND METHODS FOR OFDMA MULTI-USER CASCADING SEQUENCE OPTIMIZATION FOR WI-FI SENSING

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/293,731

(22) PCT Filed: Aug. 1, 2022
(86) PCT No.: PCT/IB2022/057105

§ 371 Date: Jan. 30, 2024

Related U.S. Application Data
(60) Provisional application No. 63/238,977, filed on Aug. 31, 2021.
(60) Provisional application No. 63/230,238, filed on Aug. 6, 2021.

(51) Int. Cl. G01S 7/00; G01S 13/00; G01S 13/86; H04W 84/12

(52) U.S. Cl. CPC G01S 7/006; G01S 13/003; G01S 13/86; H04W 84/12

(57) ABSTRACT

Systems and methods for Wi-Fi sensing are provided. A method for Wi-Fi sensing carried out by sensing receiver including a transmitting antenna, a receiving antenna, and a processor is described. Initially, a compound sensing trigger message is generated. The compound sensing trigger message is then transmitted to a sensing transmitter. A sensing response announcement transmitted by the sensing transmitter is received. Also, a sensing response null data PPDU (NDP); is received. A sensing measurement is generated based on the sensing response NDP.

### TECHNICAL FIELD

The present disclosure generally relates to systems and methods for Wi-Fi sensing. In particular, the present disclosure relates to systems and methods for orthogonal frequency division multiple access (OFDMA) multi-user cascading sequence optimization for Wi-Fi sensing.

### BACKGROUND OF THE DISCLOSURE

Motion detection systems have been used to detect movement, for example, of objects in a room or an outdoor area. In some example motion detection systems, infrared or optical sensors are used to detect the movement of objects in the sensor's field of view. Motion detection systems have been used in security systems, automated control systems, and other types of systems. A Wi-Fi sensing system is one recent addition to motion detection systems. The Wi-Fi sensing system may be a network of Wi-Fi-enabled devices that may be a part of an IEEE 802.11 network. In an example, the Wi-Fi sensing system may be configured to detect features of interest in a sensing space. The sensing space may refer to any physical space in which the Wi-Fi sensing system may operate, such as a place of residence, a place of work, a shopping mall, a sports hall or sports stadium, a garden, or any other physical space. The features of interest may include motion of objects and motion tracking, presence detection, intrusion detection, gesture recognition, fall detection, breathing rate detection, and other applications.

The IEEE P802.11ax amendment to the IEEE 802.11-2016 specification allows the scheduling and organization of parallel uplink transmissions using orthogonal frequency division multiple access (OFDMA). Multi-user (MU) cascading sequences comprise a frame exchange sequence between an access-point (AP) and one or more non-AP stations (STAs) in which the AP, within a single PPDU, acknowledges one or more frames from a STA, and triggers the STA for a further UL transmission. An MU cascading sequence is sent within a single transmission opportunity (TXOP) and may include as many trigger-transmission pairs as may be accommodated in the duration of the TXOP. Use of Uplink OFDMA (UL-OFDMA) and multi-user (MU) cascading sequence in the Wi-Fi sensing system currently enables the use of a single transmission from a sensing transmitter to a sensing receiver for each UL-OFDMA sensing trigger.

A sensing initiator may want the sensing transmitter to make a sensing transmission using a transmission configuration that is not compatible with accurate demodulation with data. The sensing transmitter may first send a sensing response announcement, followed by a sensing response null data PPDU (NDP). The sensing response announcement may inform the sensing receiver that the next transmission is a sensing transmission on which a sensing measurement should be made. The transmission of the sensing response announcement followed by the sensing response NDP currently requires two UL-OFDMA sensing triggers even though the sensing receiver knows that upon receiving the sensing response announcement from the sensing transmitter, the next transmission the sensing receiver receives from the same sensing transmitter will be the sensing response NDP on which the sensing receiver may perform a sensing measurement. The use of the MU cascading sequence in this manner therefore unnecessarily extends the TXOP, which reduces the available channel capacity for data transmissions in addition to creating additional interference in downlink due to the second UL-OFDMA sensing trigger.

### BRIEF SUMMARY OF THE DISCLOSURE

The present disclosure generally relates to systems and methods for Wi-Fi sensing. In particular, the present disclosure relates to systems and methods for orthogonal frequency division multiple access (OFDMA) multi-user cascading sequence optimization for Wi-Fi sensing.

Systems and methods are provided for Wi-Fi sensing. In an example embodiment, a method configured for Wi-Fi sensing is described. The method is carried out by a sensing receiver including a transmitting antenna, a receiving antenna, and at least one processor configured to execute instructions. The method includes generating, by the at least one processor, a compound sensing trigger message, transmitting, by the transmitting antenna, the compound sensing trigger message, receiving, via the receiving antenna, a sensing response announcement transmitted by a sensing transmitter, receiving, via the receiving antenna, a sensing response null data PPDU (NDP), and generating, by the at least one processor, a sensing measurement on the sensing response NDP.

In some embodiments, the compound sensing trigger message includes an indication for one or more sensing transmitters that a response may include two transmissions, the two transmissions including the sensing response announcement and the sensing response NDP.

In some embodiments, compound sensing trigger message includes a requested transmission configuration.

In some embodiments, the compound sensing trigger message includes an indication for one or more sensing transmitters that a response may include two transmissions if the requested transmission configuration is incompatible with accurate demodulation of data in a sensing transmission.

In some embodiments, the sensing transmitter is a first sensing transmitter, and the method includes receiving, via the receiving antenna and from a second sensing transmitter, a sensing response message having a delivered transmission configuration corresponding to a requested transmission configuration comprising at least one data packet.

In some embodiments, the method includes receiving the sensing response NDP approximately one short interframe space after receiving the sensing response announcement.

In some embodiments, the sensing response announcement includes an indication that the sensing response NDP having a delivered transmission configuration corresponding to a requested transmission configuration will be transmitted after approximately one short interframe space.

In some embodiments, receiving the sensing response announcement includes receiving a sensing transmission that contains the sensing response announcement and at least one data packet.

In some embodiments, the method includes transferring the sensing measurement to a sensing algorithm for detection of a feature of interest.

In some embodiments, the method includes processing the sensing response announcement to determine an expected delivered transmission configuration of the sensing response NDP corresponding to a requested transmission configuration.

In some embodiments, the method includes transmitting, by the transmitting antenna and responsive to generating the sensing measurement, a Multi-Sta BlockAck.

In some embodiments, the compound sensing trigger message is a first compound sensing trigger message and the method further includes generating, by the at least one processor, a second compound sensing trigger message and transmitting, by the transmitting antenna, the second compound sensing trigger message within a same transmission opportunity period as the first compound sensing trigger message.

In another example embodiment, a method configured for Wi-Fi sensing is described. The method is carried out by a sensing transmitter including a receiving antenna, a transmitting antenna, and at least one processor configured to execute instructions. The method includes receiving, via the receiving antenna, a compound sensing trigger message including a requested transmission configuration, determining, by the at least one processor, that the requested transmission configuration is incompatible with accurate demodulation of data prepared for transmission, sending, by the transmitting antenna, a sensing transmission including a sensing response announcement and the data prepared for transmission, and sending, by the transmitting antenna, subsequent to the sensing transmission, a sensing response NDP configured according to the requested transmission configuration.

In another example embodiment, a system for Wi-Fi sensing is described. The system comprises a sensing receiver including a transmitting antenna, a receiving antenna, and at least one processor configured to execute instructions for: generating, by the at least one processor, a compound sensing trigger message, transmitting, by the transmitting antenna, the compound sensing trigger message, receiving, via the receiving antenna, a sensing response announcement transmitted by a sensing transmitter, receiving, via the receiving antenna, a sensing response null data PPDU (NDP), and generating, by the at least one processor, a sensing measurement on the sensing response NDP.

In another example embodiment, a system for Wi-Fi sensing is described. The system comprises a sensing transmitter including a receiving antenna, a transmitting antenna, and at least one processor configured to execute instructions for: receiving, via the receiving antenna, a compound sensing trigger message including a requesting transmission configuration, determining, by the at least one processor, that the requested transmission configuration is incompatible with accurate demodulation of data prepared for transmission, sending, by the transmitting antenna, a sensing transmission including a sensing response announcement and the data prepared for transmission, and sending, by the transmitting antenna, subsequent to the sensing transmission, a sensing response NDP configured according to the requested transmission configuration.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIGS. 2A and 2B are diagrams showing example wireless signals communicated between wireless communication devices;

FIGS. 3A and 3B are plots showing examples of channel responses computed from the wireless signals communicated between wireless communication devices in FIGS. 2A and 2B;

FIGS. 4A and 4B are diagrams showing example channel responses associated with motion of an object in distinct regions of a space;

FIGS. 4C and 4D are plots showing the example channel responses of FIGS. 4A and 4B overlaid on an example channel response associated with no motion occurring in the space;

FIG. 5 depicts an implementation of some of an architecture of an implementation of a system for Wi-Fi sensing, according to some embodiments;

FIG. 6 depicts an exemplary UL-OFDMA based sensing transmission transaction, according to some embodiments;

FIG. 7 depicts another exemplary UL-OFDMA based sensing transmission transaction, according to some embodiments;

FIGS. 8A and 8B depicts an exemplary MU cascading sequence sensing transmission transaction, according to some embodiments;

FIGS. 9A to 9H depict a hierarchy of fields within a compound sensing trigger, according to some embodiments;

FIG. 10 depicts a flowchart for generating sensing measurements by a sensing receiver based on sensing transmissions, according to some embodiments;

FIGS. 11A and 11B depict a flowchart for transferring sensing measurements to a remote processing device for detection of a feature of interest, according to some embodiments;

FIG. 12 depicts a flowchart for generating a first compound sensing trigger message and a second compound sensing trigger message by the sensing receiver, according to some embodiments; and

FIG. 13 depicts a flowchart for sending a sensing transmission to the sensing receiver, according to some embodiments.

### DETAILED DESCRIPTION

In some aspects of what is described here, a wireless sensing system can be used for a variety of wireless sensing applications by processing wireless signals (e.g., radio frequency signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, metal detection, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi AP assumes the receiver role, and each Wi-Fi device (stations or nodes or peers) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at particular angles experience constructive interference while others experience destructive interference.

The channel information for each of the communication links may be analyzed (e.g., by a hub device or other device in a wireless communication network, or a remote device communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered less frequently. In some implementations, when motion is present, for example, the wireless sensing system can increase the triggering rate to produce a time-series of measurements with finer time resolution. Controlling the variable measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or Extended Service Set (ESS) topology, multiple coordinating wireless APs each provide a Basic Service Set (BSS) which may occupy different frequency bands and allow devices to transparently move between from one participating AP to another (e.g., mesh). For instance, within a home mesh network, Wi-Fi devices can connect to any of the APs, but typically select one with a good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP, but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area, in order to improve detection coverage, or to better localize motion within an area.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell-phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “transmission opportunity (TXOP)” may refer to a negotiated interval of time during which a particular quality of service (QoS) station (e.g., a sensing initiator or sensing transmitter) may have the right to initiate a frame exchange onto a wireless medium. A QoS access category (AC) of the transmission opportunity may be requested as part of a negotiation.

A term “Quality of Service (QoS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have differing transmission opportunity parameters defined for it.

A term “transmission parameters” may refer to a set of IEEE 802.11 PHY transmitter configuration parameters which are defined as a part of transmission vector (TXVECTOR) corresponding to a specific PHY and which are configurable for each PHY-layer protocol data unit (PPDU) transmission.

A term “Null Data PPDU (NDP)” may refer to a PPDU that does not include data field. In an example, Null Data PPDU may be used for sensing transmission where it is the MAC header that includes the information required.

A term “Channel State Information (CSI)” may refer to properties of a communications channel that are known or measured by a technique of channel estimation. CSI may represent how wireless signals propagate from a sensing transmitter to a sensing receiver along multiple paths. CSI is typically a matrix of complex values representing the amplitude attenuation and phase shift of signals, which provides an estimation of a communications channel.

A term “resource unit (RU)” may refer to an allocation of orthogonal frequency division multiplexing (OFDM) channels which may be used to carry a modulated signal. An RU may include a variable number of carriers depending on the mode of the modem.

A term “uplink orthogonal frequency division multiple access (UL-OFDMA) sensing trigger message” may refer to a message from a sensing initiator to one or more sensing transmitters that causes the one or more sensing transmitters to generate a sensing transmission in a single TXOP using UL-OFDMA. The UL-OFMDA sensing trigger message may include data that instructs the one or more sensing transmitters how to form the sensing transmissions in response to the UL-OFMDA sensing trigger message.

A term “sensing transmitter” may refer to a device that sends a transmission (for example, PPDUs) used for sensing measurements (for example, channel state information) in a sensing session. In an example, a station is an example of a sensing transmitter. In some examples, an access point may also be a sensing transmitter for Wi-Fi sensing purposes in the example where a station acts as a sensing receiver.

A term “sensing receiver” may refer to a device that receives a transmission (for example, PPDUs) sent by a sensing transmitter and performs one or more sensing measurements (for example, channel state information) in a sensing session. An access point is an example of a sensing receiver. In some examples, a station may also be a sensing receiver, for example in a mesh network scenario.

A term “sensing space” may refer to any physical space in which a Wi-Fi sensing system may operate.

A term “sensing initiator” may refer to a device that initiates a Wi-Fi sensing session. The role of sensing initiator may be taken on by the sensing receiver, the sensing transmitter, or a separate device which contains the sensing algorithm.

A “multi user (MU) cascading sequence” may refer to a sequence of frames exchanged between the sensing initiator and the one or more sensing transmitters in which the sensing initiator triggers multiple transmissions from one or more sensing transmitters within a single TXOP.

A term “Wireless Local Area Network (WLAN) sensing session” may refer to a period during which objects in a physical space may be probed, detected and/or characterized. In an example, during a WLAN sensing session, several devices participate in, and thereby contribute to the generation of sensing measurements.

A term “sensing trigger message” may refer to a message sent from a sensing transmitter to a sensing receiver to initiate or trigger one or more sensing transmissions that may be carried by an UL-OFDMA sensing trigger or an UL-OFDMA compound sensing trigger. The sensing trigger message may also be known as a sensing initiation message.

A term “sensing response message” may refer to a message which is included within the sensing transmission from the sensing transmitter to the sensing receiver. The sensing transmission that includes the sensing response message is used by the sensing receiver to perform a sensing measurement.

A term “sensing transmission” may refer to a transmission made from the sensing transmitter to the sensing receiver which may be used to make a sensing measurement. In an example, a sensing transmission may also be referred to as wireless sensing signal or wireless signal.

A term “sensing response announcement” may refer to a message that is included within a sensing transmission from a sensing transmitter to a sensing receiver that announces that a sensing response NDP will follow within a short interframe space (SIFS). The sensing response NDP may be transmitted using a requested transmission configuration.

A term “Short interframe space (SIFS)” may refer to a period within which a processing element (for example, a microprocessor, dedicated hardware, or any such element) within a device of a Wi-Fi sensing system is able to process data presented to it in a frame. In an example, the short interframe space may be 10 ms.

A term “sensing response NDP” may refer to a response transmitted by a sensing transmitter and used for a sensing measurement at a sensing receiver. The sensing response NDP may be used when a requested transmission configuration is incompatible with transmission parameters required for successful non-sensing message reception. The sensing response NDP may be announced by a sensing response announcement. In an example, the sensing response NDP may be implemented with a null data PPDU. In some examples, the sensing response NDP may be implemented with a frame that does not contain any data.

A term “non-sensing message” may refer to a message which is not originally related to sensing. In an example, the non-sensing message may include data, management, and control messages.

A term “sensing measurement” may refer to a measurement of a state of a channel between a transmitter device (for example, a sensing transmitter) and a receiver device (for example, a sensing receiver) derived from a sensing transmission. In an example, sensing measurement may also be referred to as channel response measurement.

A term “sensing goal” may refer to a goal of a sensing activity at a time. A sensing goal is not static and may change at any time. In an example, the sensing goal may require sensing measurements of a specific type, a specific format, or a specific precision, resolution, or accuracy to be available to a sensing algorithm.

A term “sensing algorithm” may refer to a computational algorithm that achieves a sensing goal. The sensing algorithm may be executed on any device in a Wi-Fi sensing system.

A term “requested transmission configuration” may refer to requested transmission parameters of a sensing transmitter to be used when sending a sensing transmission.

A term “steering matrix configuration” may refer to a matrix of complex values representing real and complex phase required to pre-condition antenna of a Radio Frequency (RF) transmission signal chain for each transmit signal. Application of the steering matrix configuration (for example, by a spatial mapper) enables beamforming and beam-steering.

A term “spatial mapper” may refer to a signal processing element that adjusts the amplitude and phase of a signal input to an RF transmission chain in a station or a sensing transmitter. The spatial mapper may include elements to process the signal to each RF chain implemented. The operation carried out is called spatial mapping. The output of the spatial mapper is one or more spatial streams.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes embodiments of systems and methods for Wi-Fi sensing. In particular, section B describes systems and methods for orthogonal frequency division multiple access (OFDMA) multi-user cascading sequence optimization for Wi-Fi sensing.

### A. Wireless Communications System, Wireless Transmissions, and Sensing Measurements

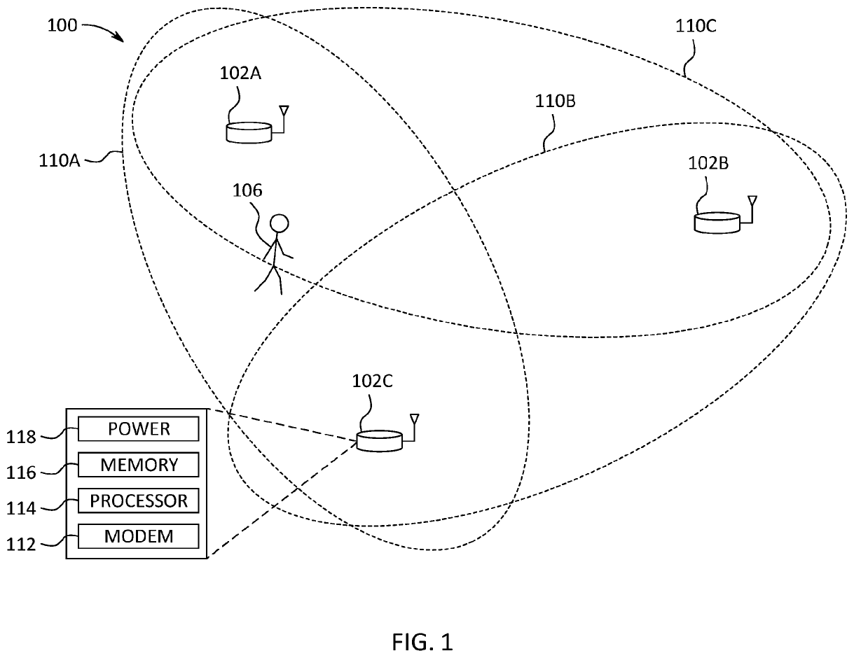

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®., Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially available Wi-Fi AP or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate radio frequency (RF) signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and radio frequency circuitry. The radio frequency circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to radio frequency (RF) signals, and wirelessly transmits the radio frequency signals (e.g., through an antenna). In some instances, the radio subsystem in modem 112 wirelessly receives radio frequency signals (e.g., through an antenna), down-converts the radio frequency signals to baseband signals, and sends the baseband signals to the baseband subsystem. The signals exchanged between the radio subsystem, and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

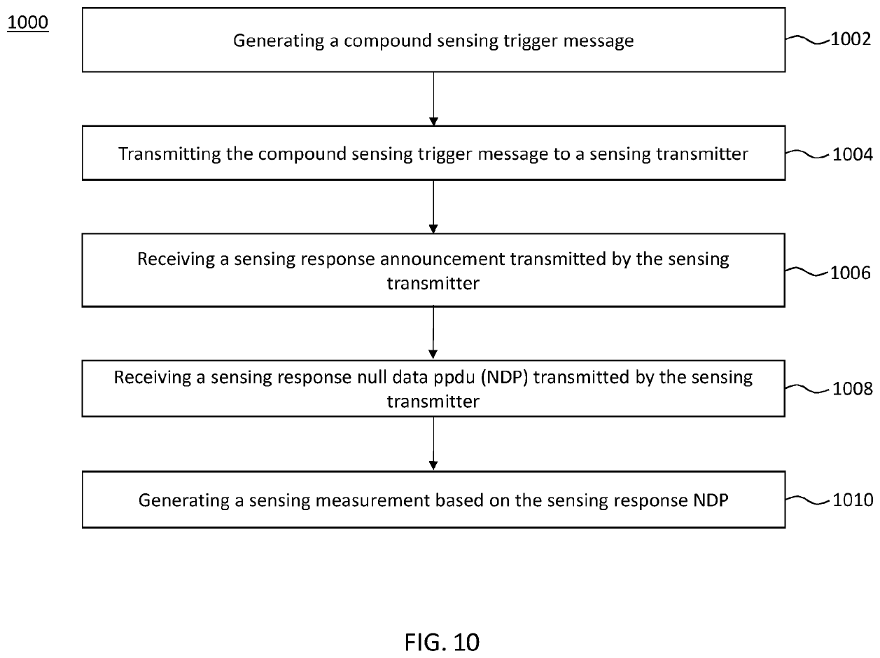

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes as described in any of FIGS. 10 to 13.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an AC adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to any of FIGS. 10 to 13, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 1101B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly), an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

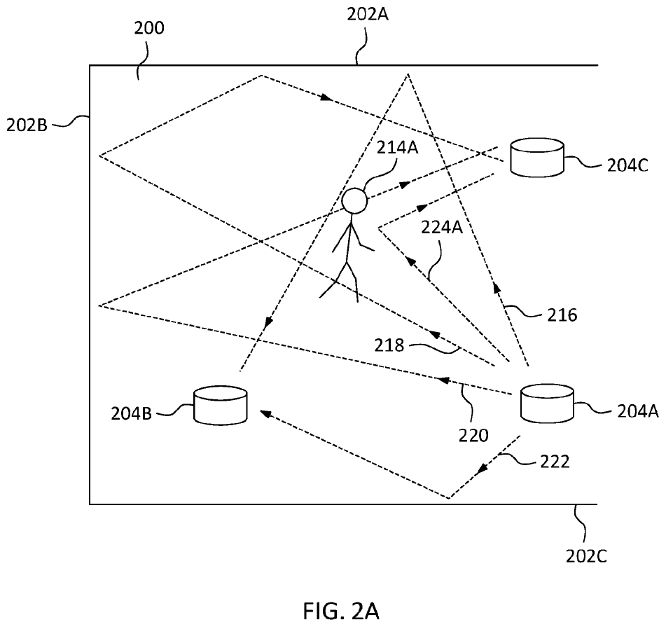

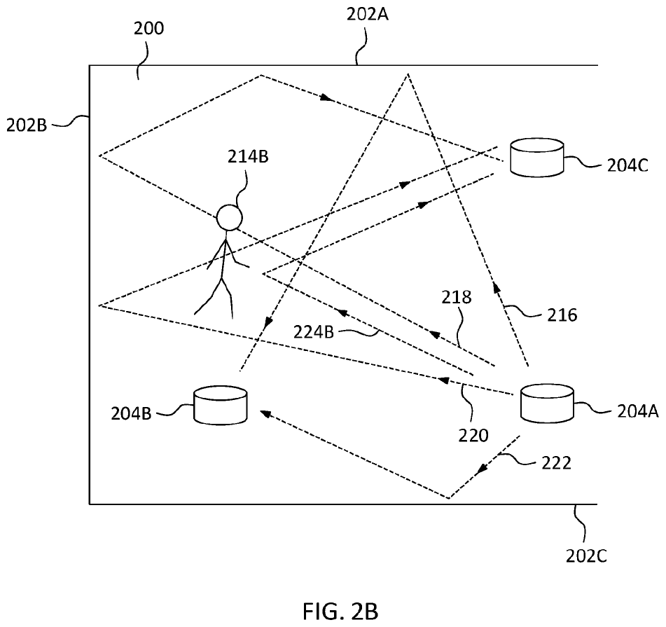

FIGS. 2A and 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIGS. 2A and 2B, wireless communication device 204A is operable to transmit wireless signals repeatedly (e.g., periodically, intermittently, at scheduled, unscheduled, or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIGS. 2A and 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIGS. 2A and 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIGS. 2A and 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIGS. 2A and 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIGS. 2A and 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIGS. 2A and 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the transmitted signal f(t) being transmitted from the first wireless communication device 204A, an output signal rₖ(t) from a path k may be described according to Equation (2):

$${r}_{k} ( t ) = {\sum }_{n = - ∞}^{∞} {α}_{n , k} {e}^{j ( {ω}_{n} t + {ϕ}_{n , k} )} \qquad ( 2 )$$

Where a_{n,k} represents an attenuation factor (or channel response; e.g., due to scattering, reflection, and path losses) for the nth frequency component along path k, and ϕ_{n,k} represents the phase of the signal for nth frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

The received signal R at a wireless communication device can then be analyzed. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency ωₙ, a complex value Hₙ may be represented as follows in Equation (5):

$${H}_{n} = {\sum }_{k} {c}_{n} {α}_{n , k} {e}^{j {ϕ}_{n , k}} \qquad ( 5 )$$

The complex value Hₙ for a given frequency component ωₙ indicates a relative magnitude and phase offset of the received signal at that frequency component ωₙ. When an object moves in the space, the complex value Hₙ changes due to the channel response a_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response h_{ch} for a space can be determined, for example, based on the mathematical theory of estimation. For instance, a reference signal R_{ef} can be modified with candidate channel responses (h_{ch}), and then a maximum likelihood approach can be used to select the candidate channel which gives best match to the received signal (R_{cvd}). In some cases, an estimated received signal (\hat{R}_{cvd}) is obtained from the convolution of the reference signal (R_{ef}) with the candidate channel responses (h_{ch}), and then the channel coefficients of the channel response (h_{ch}) are varied to minimize the squared error of the estimated received signal (\hat{R}_{cvd}). This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion

$${min}_{{h}_{ch}} \sum {( {\hat{R}}_{cvd} - {R}_{cvd} )}^{2}$$

The minimizing, or optimizing, process can utilize an adaptive filtering technique, such as Least Mean Squares (LMS), Recursive Least Squares (RLS), Batch Least Squares (BLS), etc. The channel response can be a Finite Impulse Response (FIR) filter, Infinite Impulse Response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

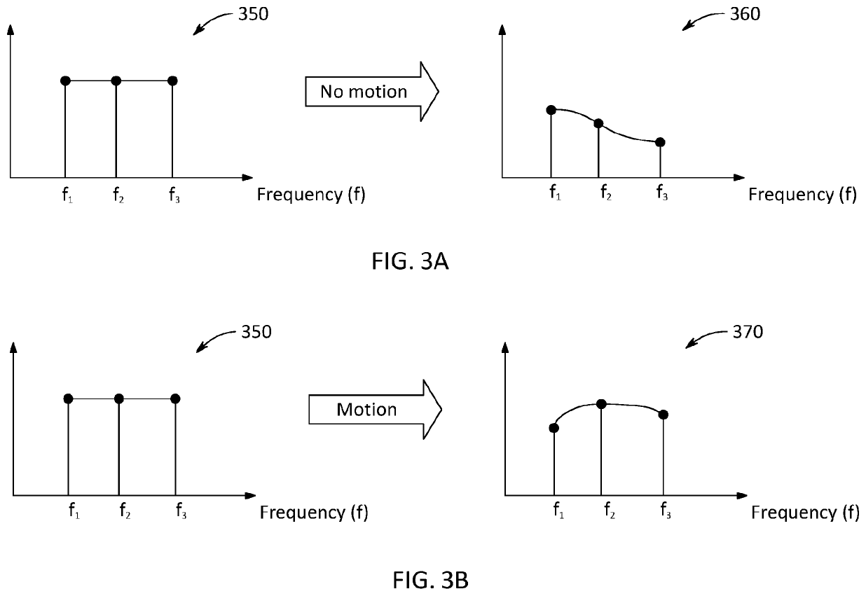

FIGS. 3A-3B are plots showing examples of channel responses 360, 370 computed from the wireless signals communicated between wireless communication devices 204A, 204B, 204C in FIGS. 2A-2B. FIGS. 3A-3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIGS. 3A-3B, for illustration purposes, wireless communication device 204A transmits a signal that has a flat frequency profile (the magnitude of each frequency component f₁, f₂, and f₃ is the same), as shown in frequency domain representation 350. Because of the interaction of the signal with space 200 (and the objects therein), the signals received at wireless communication device 204B that are based on the signal sent from wireless communication device 204A look different from the transmitted signal. In this example, where the transmitted signal has a flat frequency profile, the received signal represents the channel response of space 200. As shown in FIGS. 3A-3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

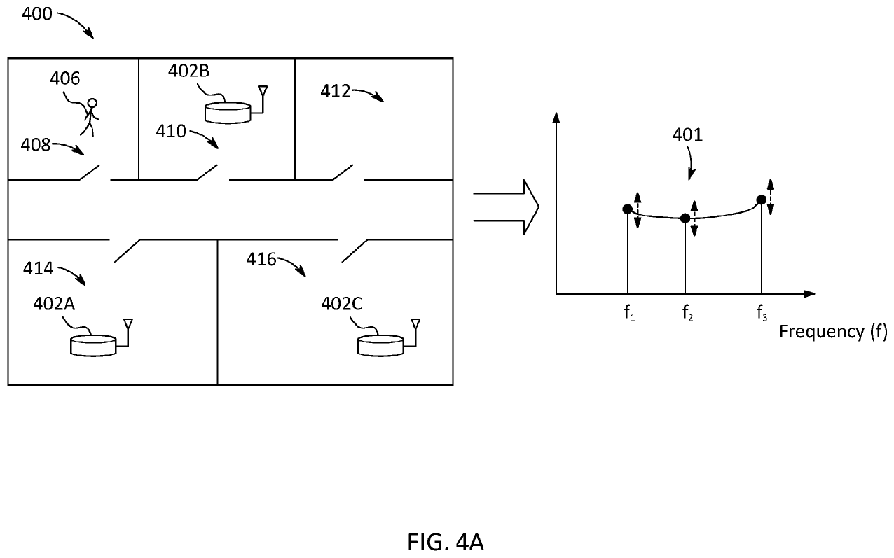

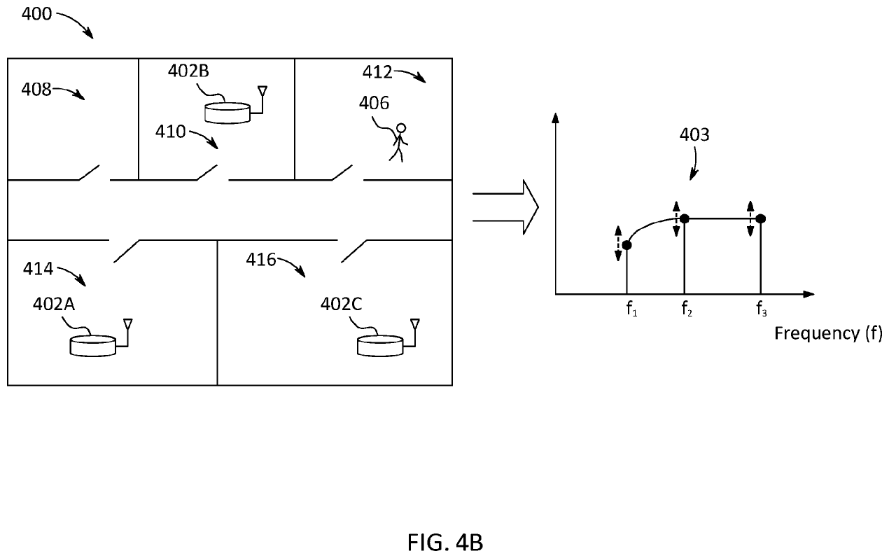

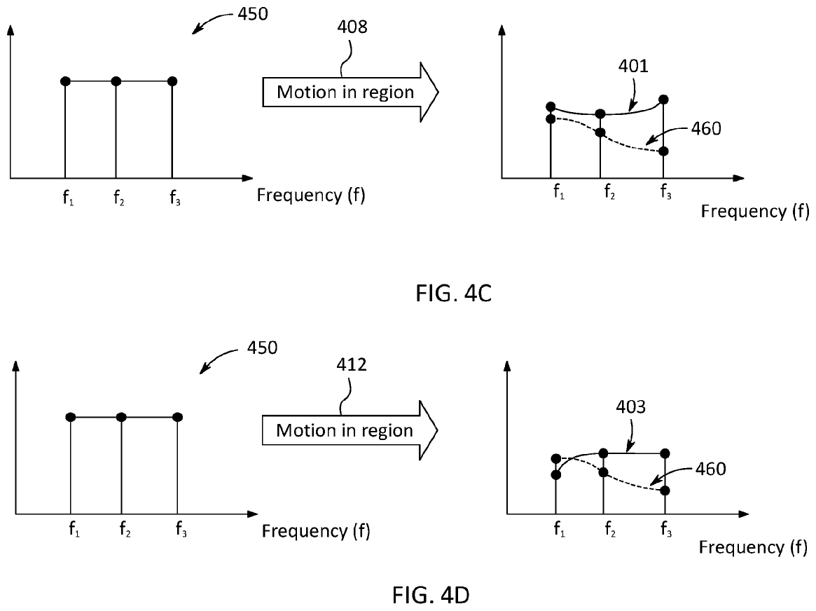

FIGS. 4A-4B are diagrams showing example channel responses 401, 403 associated with motion of object 406 in distinct regions 408, 412 of space 400. In the examples shown, space 400 is a building, and space 400 is divided into a plurality of distinct regions—first region 408, second region 410, third region 412, fourth region 414, and fifth region 416. Space 400 may include additional or fewer regions, in some instances. As shown in FIGS. 4A-4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 106, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of each frequency component f₁, f₂, and f₃. For example, the motion probe signals may have a frequency response similar to frequency domain representation 350 shown in FIGS. 3A-3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIGS. 4C-4D are plots showing channel responses 401, 403 of FIGS. 4A-4B overlaid on channel response 460 associated with no motion occurring in space 400. FIGS. 4C-4D also show frequency domain representation 450 of an initial wireless signal transmitted by one or more of wireless communication devices 402A, 402B, 402C. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained Al model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each frequency component f₁, f₂, and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIGS. 4C-4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component f₂ is less than the outer frequency components f₁ and f₃), while channel response 403 has a convex-asymptotic frequency profile (the magnitude of the middle frequency component f₂ is greater than the outer frequency components f₁ and f₃). The profiles of channel responses 401, 403 may differ in some instances (e.g., based on different room layouts or placement of the wireless communication devices 402).

Analyzing channel responses may be considered similar to analyzing a digital filter. In other words, a channel response has been formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an artificial intelligence (AI) model may be used to process data. Al models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all Al models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIGS. 4A-4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an Al model may be trained using the tagged channel responses, and once trained, newly computed channel responses can be input to the Al model, and the Al model can output a location of the detected motion. For example, in some cases, mean, range, and absolute values are input to an Al model. In some instances, magnitude and phase of the complex channel response itself may be input as well. These values allow the Al model to design arbitrary front-end filters to pick up the features that are most relevant to making accurate predictions with respect to motion in distinct regions of a space. In some implementations, the Al model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an Al model includes two or more layers of inference. The first layer acts as a logistic classifier which can divide different concentration of values into separate clusters, while the second layer combines some of these clusters together to create a category for a distinct region. Additional, subsequent layers can help in extending the distinct regions over more than two categories of clusters. For example, a fully-connected Al model may include an input layer corresponding to the number of features tracked, a middle layer corresponding to the number of effective clusters (through iterating between choices), and a final layer corresponding to different regions. Where complete channel response information is input to the Al model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Systems and Methods for OFDMA Multi-User Cascading Sequence Optimization for Wi-Fi Sensing

The present disclosure generally relates to systems and methods for Wi-Fi sensing. In particular, the present disclosure relates to systems and methods for orthogonal frequency division multiple access (OFDMA) multi-user cascading sequence optimization for Wi-Fi sensing.

The present disclosure modifies the use of UL-OFDMA response via a trigger-based PPDU and MU cascading sequence to permit at least two uplink transmissions for each compound sensing trigger message. In an example implementation, the use of an UL-OFDMA compound sensing trigger and MU cascading sequence is modified to permit a response to each compound sensing trigger message with either a sensing response message or a sensing response NDP as a sensing transmission and to support up to two uplink transmissions for each compound sensing trigger message. Accordingly, the present disclosure provides an efficient way of triggering a series of sensing transmissions using UL-OFDMA and MU cascading sequence in situations where a sensing response NDP or a mixture of sensing response message and sensing response NDP are required.

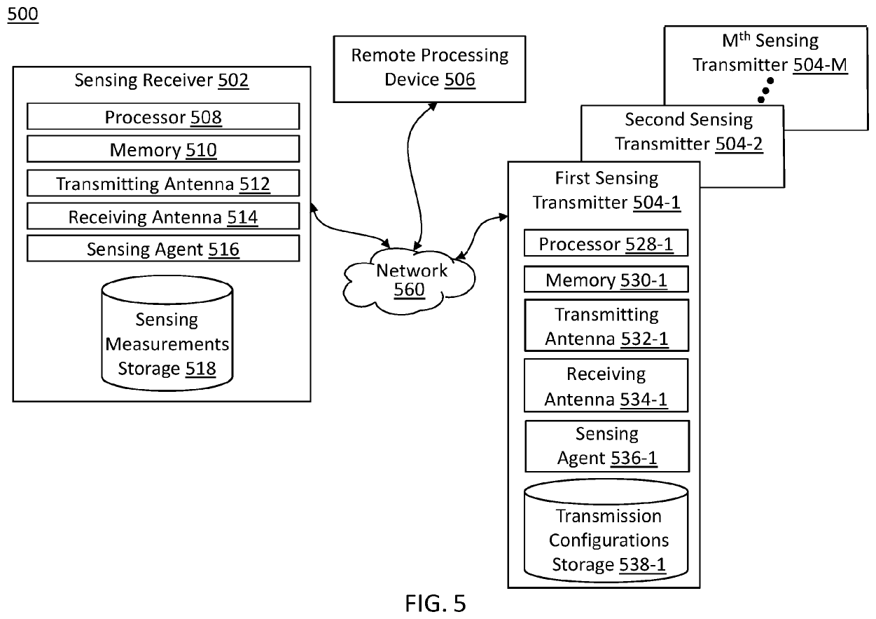

FIG. 5 depicts an implementation of some of an architecture of an implementation of system 500 for Wi-Fi sensing, according to some embodiments.

System 500 may include sensing receiver 502, plurality of sensing transmitters 504-(1-M), remote processing device 506, and network 560 enabling communication between the system components for information exchange. In an example implementation, plurality of sensing transmitters 504-(1-M) may include at least first sensing transmitter 504-1 and second sensing transmitter 504-2. System 500 may be an example or instance of wireless communication system 100 and network 560 may be an example or instance of wireless network or cellular network, details of which are provided with reference to FIG. 1 and its accompanying description.

According to an embodiment, sensing receiver 502 may be configured to receive a sensing transmission (for example, from each of plurality of sensing transmitters 504-(1-M)), and perform one or more measurements (for example, CSI) useful for Wi-Fi sensing. These measurements may be known as sensing measurements. The sensing measurements may be processed to achieve a sensing goal of system 500. In an embodiment, sensing receiver 502 may be an AP. In some embodiments, sensing receiver 502 may take a role of sensing initiator.

According to an implementation, sensing receiver 502 may be implemented by a device, such as wireless communication device 102 shown in FIG. 1. In some implementations, sensing receiver 502 may be implemented by a device, such as wireless communication device 204 shown in FIGS. 2A and 2B. Further, sensing receiver 502 may be implemented by a device, such as wireless communication device 402 shown in FIGS. 4A and 4B. In an implementation, sensing receiver 502 may coordinate and control communication among plurality of sensing transmitters 504-(1-M). According to an implementation, sensing receiver 502 may be enabled to control a measurement campaign to ensure that required sensing transmissions are made at a required time and to ensure an accurate determination of sensing measurement. In some embodiments, sensing receiver 502 may process sensing measurements to achieve the sensing goal of system 500. In some embodiments, sensing receiver 502 may be configured to transmit sensing measurements to remote processing device 506, and remote processing device 506 may be configured to process the sensing measurements to achieve the sensing goal of system 500.

Referring again to FIG. 5, in some embodiments, each of plurality of sensing transmitters 504-(1-M) may form a part of a Basic Service Set (BSS) and may be configured to send a sensing transmission to sensing receiver 502 based on which, one or more sensing measurements (for example, CSI) may be performed for Wi-Fi sensing. In an embodiment, each of plurality of sensing transmitters 504-(1-M) may be a station. According to an implementation, each of plurality of sensing transmitters 504-(1-M) may be implemented by a device, such as wireless communication device 102 shown in FIG. 1. In some implementations, each of plurality of sensing transmitters 504-(1-M) may be implemented by a device, such as wireless communication device 204 shown in FIGS. 2A and 2B. Further, each of plurality of sensing transmitters 504-(1-M) may be implemented by a device, such as wireless communication device 402 shown in FIGS. 4A and 4B. In some implementations, communication between sensing receiver 502 and each of plurality of sensing transmitters 504-(1-M) may happen via Station Management Entity (SME) and MAC Layer Management Entity (MLME) protocols.

In some embodiments, remote processing device 506 may be configured to receive sensing measurements from sensing receiver 502 and process the sensing measurements. In an example, remote processing device 506 may process and analyze the sensing measurements to identify one or more features of interest. According to some implementations, remote processing device 506 may include/execute a sensing algorithm. In an embodiment, remote processing device 506 may be a station. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIGS. 2A and 2B. Further, remote processing device 506 may be implemented by a device, such as wireless communication device 402 shown in FIGS. 4A and 4B. In some embodiments, remote processing device 506 may be any computing device, such as a desktop computer, a laptop, a tablet computer, a mobile device, a Personal Digital Assistant (PDA) or any other computing device. In embodiments, remote processing device 506 may take a role of sensing initiator where a sensing algorithm determines a measurement campaign and the sensing measurements required to fulfill the measurement campaign. Remote processing device 506 may communicate the sensing measurements required to fulfill the measurement campaign to sensing receiver 502 to coordinate and control communication among plurality of sensing transmitters 504-(1-M).

Referring to FIG. 5, in more detail, sensing receiver 502 may include processor 508 and memory 510. For example, processor 508 and memory 510 of sensing receiver 502 may be processor 114 and memory 116, respectively, as shown in FIG. 1. In an embodiment, sensing receiver 502 may further include transmitting antenna(s) 512, receiving antenna(s) 514, and sensing agent 516. In some embodiments, an antenna may be used to both transmit and receive signals in a half-duplex format. When the antenna is transmitting, it may be referred to as transmitting antenna 512, and when the antenna is receiving, it may be referred to as receiving antenna 514. It is understood by a person of normal skill in the art that the same antenna may be transmitting antenna 512 in some instances and receiving antenna 514 in other instances. In the case of an antenna array, one or more antenna elements may be used to transmit or receive a signal, for example, in a beamforming environment. In some examples, a group of antenna elements used to transmit a composite signal may be referred to as transmitting antenna 512, and a group of antenna elements used to receive a composite signal may be referred to as receiving antenna 514. In some examples, each antenna is equipped with its own transmission and receive paths, which may be alternately switched to connect to the antenna depending on whether the antenna is operating as transmitting antenna 512 or receiving antenna 514.

In an implementation, sensing agent 516 may be responsible for receiving sensing transmissions and associated transmission parameters, calculating sensing measurements, and processing sensing measurements to fulfill a sensing goal. In some implementations, receiving sensing transmissions and associated transmission parameters, and calculating sensing measurements may be carried out by an algorithm running in the Medium Access Control (MAC) layer of sensing receiver 502 and processing sensing measurements in to fulfill a sensing goal may be carried out by an algorithm running in the application layer of sensing receiver 502. In examples, the algorithm running in the application layer of sensing receiver 502 is known as Wi-Fi sensing agent, sensing application, or sensing algorithm. In some implementations, the algorithm running in the MAC layer of sensing receiver 502 and the algorithm running in the application layer of sensing receiver 502 may run separately on processor 508. In an implementation, sensing agent 516 may pass physical layer parameters (e.g., such as CSI) from the MAC layer of sensing receiver 502 to the application layer of sensing receiver 502 and may use the physical layer parameters to detect one or more features of interest. In an example, the application layer may operate on the physical layer parameters and form services or features, which may be presented to an end-user. According to an implementation, communication between the MAC layer of sensing receiver 502 and other layers or components may take place based on communication interfaces, such as MLME interface and a data interface. According to some implementations, sensing agent 516 may include/execute a sensing algorithm. In an implementation, sensing agent 516 may process and analyze sensing measurements using the sensing algorithm, and identify one or more features of interest. Further, sensing agent 516 may be configured to determine a number and timing of sensing transmissions and sensing measurements for the purpose of Wi-Fi sensing. In some implementations, sensing agent 516 may be configured to transmit sensing measurements to remote processing device 506 for further processing.

In an implementation, sensing agent 516 may be configured to cause at least one transmitting antenna of transmitting antenna(s) 512 to transmit messages to plurality of sensing transmitters 504-(1-M). Further, sensing agent 516 may be configured to receive, via at least one receiving antenna of receiving antennas(s) 514, messages from plurality of sensing transmitters 504-(1-M). In an example, sensing agent 516 may be configured to make sensing measurements based on sensing transmissions received from plurality of sensing transmitters 504-(1-M). According to an implementation, sensing agent 516 may be configured to process and analyze the sensing measurements to identify one or more features of interest.

In some embodiments, sensing receiver 502 may include sensing measurements storage 518. In an implementation, sensing measurements storage 518 may store sensing measurements computed by sensing receiver 502 based on sensing transmissions. Information related to the sensing measurements stored in sensing measurements storage 518 may be periodically or dynamically updated as required. In an implementation, sensing measurements storage 518 may include any type or form of storage, such as a database or a file system or coupled to memory 510.

Referring again to FIG. 5, first sensing transmitter 504-1 may include processor 528-1 and memory 530-1. For example, processor 528-1 and memory 530-1 of first sensing transmitter 504-1 may be processor 114 and memory 116, respectively, as shown in FIG. 1. In an embodiment, first sensing transmitter 504-1 may further include transmitting antenna(s) 532-1, receiving antenna(s) 534-1, and sensing agent 536-1. In an implementation, sensing agent 536-1 may be a block that passes physical layer parameters from the MAC of first sensing transmitter 504-1 to application layer programs. Sensing agent 536-1 may be configured to cause at least one transmitting antenna of transmitting antenna(s) 532-1 and at least one receiving antenna of receiving antennas(s) 534-1 to exchange messages with sensing receiver 502. In some embodiments, an antenna may be used to both transmit and receive in a half-duplex format. When the antenna is transmitting, it may be referred to as transmitting antenna 532-1, and when the antenna is receiving, it may be referred to as receiving antenna 534-1. It is understood by a person of normal skill in the art that the same antenna may be transmitting antenna 532-1 in some instances and receiving antenna 534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 532-1, and a group of antenna elements used to receive a composite signal may be referred to as receiving antenna 534-1. In some examples, each antenna is equipped with its own transmission and receive paths, which may be alternately switched to connect to the antenna depending on whether the antenna is operating as transmitting antenna 532-1 or receiving antenna 534-1.

In some embodiments, first sensing transmitter 504-1 may include transmission configurations storage 538-1. Transmission configurations storage 538-1 may store requested transmission configuration and/or steering matrix configuration requested by sensing receiver 502 to first sensing transmitter 504-1 or delivered transmission configuration and/or steering matrix configuration delivered by first sensing transmitter 504-1 to sensing receiver 502. Information regarding transmission configurations stored in transmission configurations storage 538-1 may be periodically or dynamically updated as required. In an implementation, transmission configurations storage 538-1 may include any type or form of storage, such as a database or a file system or coupled to memory 530-1.

For ease of explanation and understanding, the description provided above is with reference to first sensing transmitter 504-1, however, the description is equally applicable to remaining sensing transmitters 504-(2-M).

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully-ratified standards whilst IEEE 802.11me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax adopted OFDMA, which allows sensing receiver 502 to simultaneously transmit data to all participating devices, such as plurality of sensing transmitters 504-(1-M), and vice versa using a single TXOP. The efficiency of OFDMA depends on how sensing receiver 502 schedules channel resources (interchangeably referred to as resource units (RUs)) among plurality of sensing transmitters 504-(1-M) and configures transmission parameters. According to an implementation, system 500 may be an OFDMA 802.11ax enabled system.

Referring back to FIG. 5, according to one or more implementations, sensing receiver 502 may initiate a measurement campaign. In the measurement campaign, exchange of transmissions between sensing receiver 502 and plurality of sensing transmitters 504-(1-M) may occur. In an example, control of these transmissions may be with the MAC (Medium Access Control) layer of the IEEE 802.11 stack. According to an implementation, sensing receiver 502 may secure a TXOP which may be allocated to one or more sensing transmissions by selected sensing transmitters. In an example, the selected sensing transmitters may include plurality of sensing transmitters 504-(1-M). In some examples, the selected sensing transmitters may include a subset of plurality of sensing transmitters 504-(1-M). According to an example, the subset of plurality of sensing transmitters 504-(1-M) may include one or more sensing transmitters. For example, subset of plurality of sensing transmitters 504-(1-M) may include one or more of first sensing transmitter 504-1, second sensing transmitter 504-2, third sensing transmitter 504-3, and fourth sensing transmitter 504-4. For ease of explanation and understanding, the description hereinafter is provided with reference to the selected sensing transmitters including the subset of plurality of sensing transmitters 504-(1-M) (i.e., one or more sensing transmitters), however the description is equally applicable to the case of plurality of sensing transmitters 504-(1-M). According to an implementation, sensing receiver 502 may allocate channel resources (or RUs) within a TXOP to the selected sensing transmitters. In an example, sensing receiver 502 may allocate the channel resources to the selected sensing transmitters by allocating time and bandwidth within the TXOP to the selected sensing transmitters.

According to an implementation, sensing receiver 502 may initiate a measurement campaign. In an implementation, sensing agent 516 may generate a compound sensing trigger message configured to trigger a response from each of the one or more sensing transmitters. In an example, the one or more sensing transmitters may include at least one of first sensing transmitter 504-1, second sensing transmitter 504-2, third sensing transmitter 504-3, and fourth sensing transmitter 504-4. In an example, the response may be one or more sensing transmissions.

According to an example, the compound sensing trigger message may be an UL-OFDMA compound sensing trigger message which may instruct the one or more sensing transmitters to make the response using UL-OFDMA. In an implementation, the compound sensing trigger message may include a requested transmission configuration and/or steering matrix configuration for each of the one or more sensing transmitters that the compound sensing trigger message is triggering. In an example, the requested transmission configuration and/or steering matrix configuration may be identical for each of the one or more sensing transmitters. In some examples, the requested transmission configuration and/or steering matrix configuration may be different for each of the one or more sensing transmitters. In an example, the requested transmission configuration and/or steering matrix configuration may differ according to the requirements of the sensing transmissions being triggered.

In an implementation, the compound sensing trigger message may include an indication for the one or more sensing transmitters that the response may include one (or a single) transmission. In an example, the one transmission may include a sensing response message. In some implementations, the compound sensing trigger message may include an indication for the one or more sensing transmitters that the response may include two transmissions. The two transmissions may include a sensing response announcement and a sensing response NDP. In an example, the sensing response announcement may be followed by the sensing response NDP after approximately one short interframe space (SIFS). In an example, the duration of SIFS is 10 μs. Accordingly, the compound sensing trigger message may instruct each of the one or more sensing transmitters to respond with either the sensing response message or the sensing response announcement followed by the sensing response NDP. Therefore, up to two uplink transmissions from each of the one or more sensing transmitters are supported using the compound sensing trigger message. In some implementations, the compound sensing trigger message may include a request that the one or more sensing transmitters respond with time-synchronized sensing transmissions.

According to an implementation, the compound sensing trigger message may include a resource allocation field and a requested transmission configuration field. In an example, the compound sensing trigger message may inform the one or more sensing transmitters of their allocation of RUs within the uplink bandwidth for use in the TXOP using the resource allocation field. In some examples, the compound sensing trigger message may include parameters which may instruct the one or more sensing transmitters on further configuration items for resulting sensing transmissions using the requested transmission configuration field. In an implementation, sensing agent 516 may generate the compound sensing trigger message with a specification of a steering matrix configuration included. In an example, compound sensing trigger message may include the steering matrix configuration within the requested transmission configuration field.

According to an implementation, the compound sensing trigger message may include an indication for each of the one or more sensing transmitters that the response may include one transmission if the requested transmission configuration and/or steering matrix configuration is compatible with accurate demodulation of data in a sensing transmission. In an example, the one transmission may include a sensing response message. In some implementations, the compound sensing trigger message may include an indication for each of the one or more sensing transmitters that the response may include two transmissions if the requested transmission configuration and/or steering matrix configuration is incompatible with accurate demodulation of data in a sensing transmission. In an example, the two transmissions may include a sensing response announcement and a sensing response NDP, where the sensing response announcement is followed by the sensing response NDP.

According to an implementation, sensing agent 516 may transmit the compound sensing trigger message to the one or more sensing transmitters. In an implementation, sensing agent 516 may transmit the compound sensing trigger message to the one or more sensing transmitters via transmitting antenna 512. In an example, sensing agent 516 may transmit the compound sensing trigger message to each of first sensing transmitter 504-1, second sensing transmitter 504-2, third sensing transmitter 504-3, and fourth sensing transmitter 504-4.

Referring back to FIG. 5, the one or more sensing transmitters may receive the compound sensing trigger message. In response to receiving the compound sensing trigger message, each of the one or more sensing transmitters may generate one or more sensing transmissions. In an example, the one or more sensing transmissions may be either a sensing response message or a sensing response announcement followed by a sensing response NDP. In an implementation, each of the one or more sensing transmitters may generate the one or more sensing transmissions using the requested transmission configuration and/or steering matrix configuration defined by the compound sensing trigger message.

According to an implementation, after receiving the compound sensing trigger message, each of the one or more sensing transmitters may analyze the requested transmission configuration and/or steering matrix configuration to determine if the requested transmission configuration and/or steering matrix configuration is compatible with accurate demodulation of data prepared for transmission or not. In scenarios where a sensing transmitter determines that a requested transmission configuration and/or steering matrix configuration is compatible with the accurate demodulation of data prepared for transmission, the sensing transmitter may generate a sensing response message having a delivered transmission configuration and/or steering matrix configuration corresponding to the requested transmission configuration and/or steering matrix configuration, respectively. In some scenarios where a sensing transmitter determines that a requested transmission configuration and/or steering matrix configuration is incompatible with the accurate demodulation of data prepared for transmission, the sensing transmitter may generate a sensing response NDP. In such scenarios, a sensing response announcement may be created using a delivered transmission configuration and/or steering matrix configuration. According to some scenarios, the sensing response announcement may be optional and may not be created.

According to an implementation, each of the one or more sensing transmitters may send the one or more sensing transmissions to sensing receiver 502 as a response to the compound sensing trigger message. According to an implementation, each of the one or more sensing transmitters may send its designated message (i.e., the one or more sensing transmissions) one SIFS after receiving the compound sensing trigger message.

In an example, the one or more sensing transmissions may be either a sensing response message or a sensing response announcement followed by a sensing response NDP. In an example implementation, the sensing response announcement may include an indication that the sensing response NDP will be transmitted after approximately one SIFS. Accordingly, the sensing response NDP may be sent approximately one SIFS after sending the sensing transmission (i.e., the sensing response announcement). Therefore, when a requested transmission configuration and/or steering matrix configuration for a sensing transmission is not compatible with the accurate demodulation of data which means that data which may be transferred as part of a sensing transmission may not be received by sensing receiver 502, then two sensing transmissions may be sent to sensing receiver 502. First being a sensing response announcement, which is transmitted with transmission parameters that ensures successful data transfer. Second being a sensing response NDP, which is transmitted with transmission parameters required for the sensing transmission. In some examples, the sensing response announcement is not created (i.e., is optional and omitted only a single sensing response NDP may be sent to sensing receiver 502.

According to the implementation, all sensing transmitters may respond to the compound sensing trigger message with a sensing response announcement and a sensing response NDP. In some implementations, all sensing transmitters may respond to the compound sensing trigger message with a sensing response message. In some implementations, some sensing transmitters may respond to the compound sensing trigger message with a sensing response message, and some sensing transmitters may respond to the compound sensing trigger message with a sensing response announcement following one SIFS later by a sensing response NDP. In an example, first sensing transmitter 504-1 may respond with a sensing response announcement following one SIFS later by a sensing response NDP, and second sensing transmitter 504-2 may respond with a sensing response message.

According to an implementation, in scenarios where a sensing transmitter responds with a sensing response announcement then the sensing transmitter may reconfigure its transmission parameters and spatial mapper to correspond to the requested transmission configuration and the steering matrix configuration and generate a sensing response NDP in the same RU allocation described in compound sensing trigger message and used to send the sensing response announcement. In an example, the sensing transmitter may send a sensing response NDP after a period of one SIFS from sending the sensing response announcement, or after a period of one SIFS from the reception of the compound sensing trigger message if the sensing response announcement has been omitted. In an example, the RU allocation described in the compound sensing trigger message allocates the full channel bandwidth to the sensing transmitter for the transmission of a sensing response NDP. In an example, the sensing transmitter transmits the sensing response NDP using the full channel bandwidth RU allocation and using a spatial stream configured using the steering matrix configuration in the compound sensing trigger message.

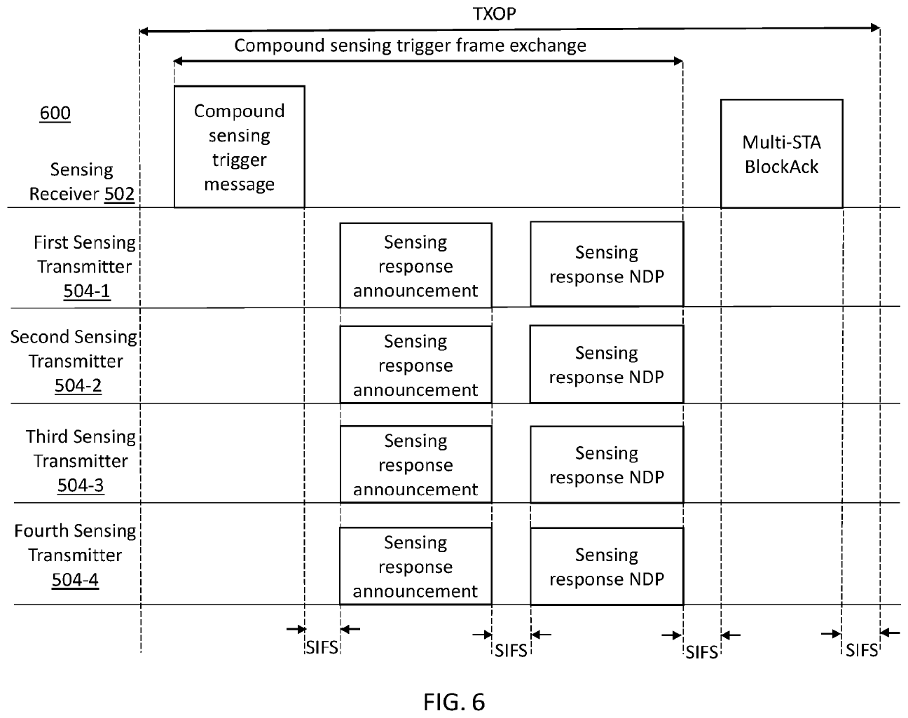

FIG. 6 depicts exemplary UL-OFDMA based sensing transmission transaction 600, according to some embodiments.

In the example shown in FIG. 6, sensing receiver 502 transmits a single compound sensing trigger message to trigger sensing transmissions from first sensing transmitter 504-1, second sensing transmitter 504-2, third sensing transmitter 504-3, and fourth sensing transmitter 504-4. Sensing receiver 502 secured a single TXOP for exchange of transmissions between sensing receiver 502 and first sensing transmitter 504-1, second sensing transmitter 504-2, third sensing transmitter 504-3, and fourth sensing transmitter 504-4. In response to the compound sensing trigger message, each of first sensing transmitter 504-1, second sensing transmitter 504-2, third sensing transmitter 504-3, and fourth sensing transmitter 504-4 respond, after a period of one SIFS, with a sensing response announcement followed after one further SIFS by a sensing response NDP. In an implementation, sensing receiver 502 acknowledges the responses from first sensing transmitter 504-1, second sensing transmitter 504-2, third sensing transmitter 504-3, and fourth sensing transmitter 504-4. In an example implementation, sensing receiver 502 transmits a Multi-STA BlockAck to first sensing transmitter 504-1, second sensing transmitter 504-2, third sensing transmitter 504-3, and fourth sensing transmitter 504-4.

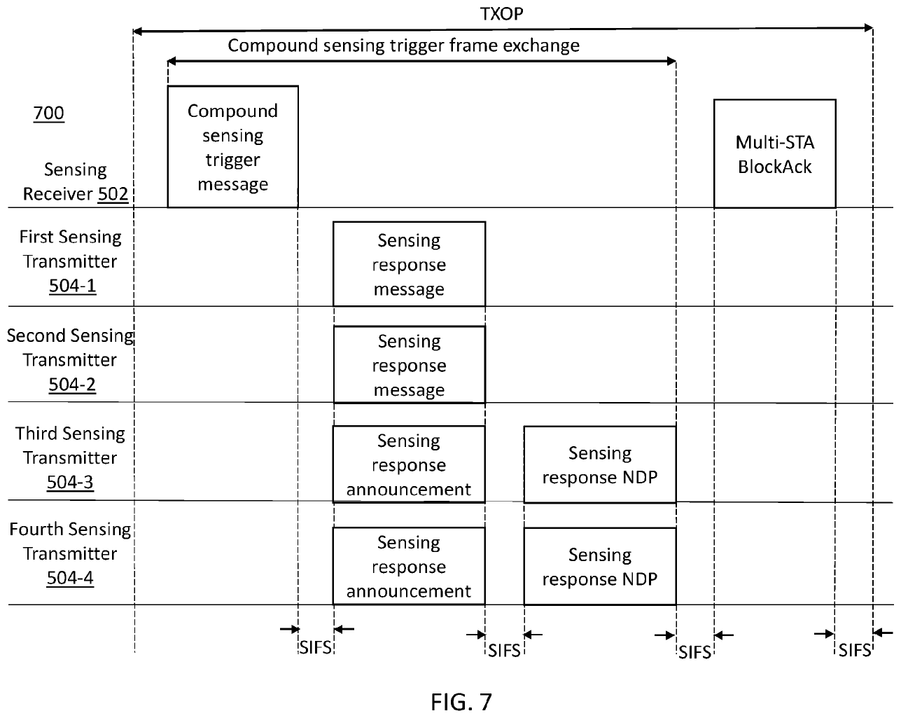

FIG. 7 depicts another exemplary UL-OFDMA based sensing transmission transaction 700, according to some embodiments.

In the example shown in FIG. 7, sensing receiver 502 transmits a single compound sensing trigger message to trigger sensing transmissions from first sensing transmitter 504-1, second sensing transmitter 504-2, third sensing transmitter 504-3, and fourth sensing transmitter 504-4. Sensing receiver 502 secured a single TXOP for exchange of transmissions between sensing receiver 502 and first sensing transmitter 504-1, second sensing transmitter 504-2, third sensing transmitter 504-3, and fourth sensing transmitter 504-4. In an example, the determination whether to respond with a sensing response message or a sensing response announcement following one SIFS later by a sensing response NDP is made by each of first sensing transmitter 504-1, second sensing transmitter 504-2, third sensing transmitter 504-3, and fourth sensing transmitter 504-4 independently and in response to the compound sensing trigger message. As described in FIG. 7, in response to the compound sensing trigger message, each of first sensing transmitter 504-1 and second sensing transmitter 504-2 respond with a sensing response message, and each of third sensing transmitter 504-3 and fourth sensing transmitter 504-4 respond with a sensing response announcement following one SIFS later by a sensing response NDP.

In some embodiments the determination whether to respond with a sensing response message or a sensing response announcement is made by the sensing transmitters 504-(1-M) based upon at least the requested transmission configuration and steering matrix configuration of the received compound sensing trigger message. In some embodiments the determination is based upon a request from sensing receiver 502 in the compound sensing trigger message.

According to one or more embodiments, in scenarios where the requirements of sensing agent 516 necessitate sensing transmissions from the one or more sensing transmitters that collectively exceed the available uplink bandwidth, a MU cascading sequence may be used. In an implementation, the use of the compound sensing trigger message may be combined with the MU cascading sequence, for instance, in the case where there is insufficient bandwidth for the one or more sensing transmitters to respond in the same sensing transmission frame exchange.

According to an implementation, the MU cascading sequence may allow multiple compound sensing trigger messages and sensing transmissions to be made in a single TXOP. In an implementation, the MU cascading sequence may enable sensing agent 516 to solicit sensing transmissions from multiple sensing transmitters in a single TXOP even if the total aggregate bandwidth of those sensing transmissions exceeds the uplink channel bandwidth. In an implementation, the MU cascading sequence may support a combination of sensing response messages, sensing response announcements, and sensing response NDPs in each compound sensing trigger frame exchange.

In an example, where an AC_VO or AC_VI QoS AC has been negotiated for a TXOP, MU cascading sequence may be used to allow multiple compound sensing trigger messages to trigger multiple compound sensing trigger frame exchanges between sensing receiver 502 and sensing transmitters in the TXOP. In the example, sensing receiver 502 may trigger as many sensing transmissions as can be accommodated in the duration of the TXOP. According to an example, the sensing transmissions which follow the compound sensing trigger message may be sensing response messages or may be sensing response NDPs.

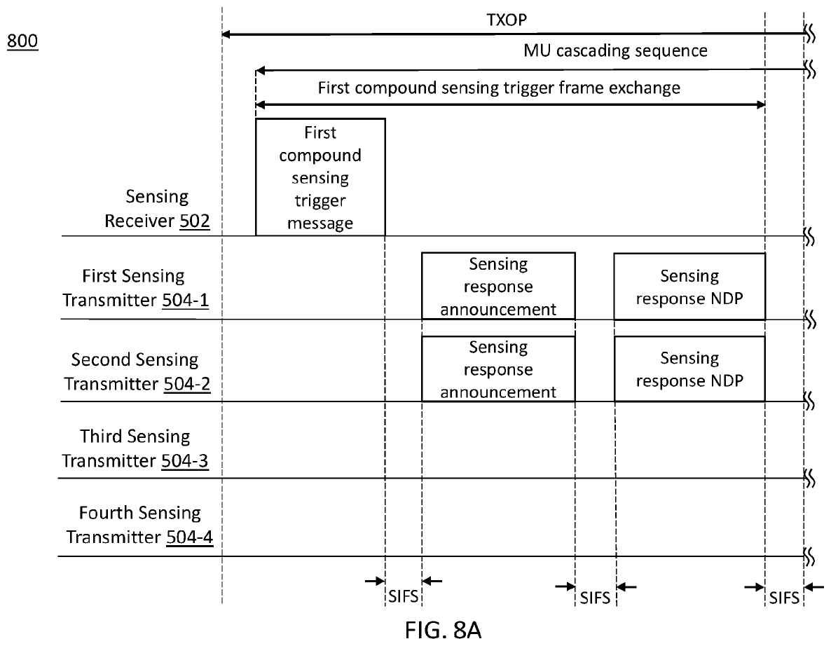

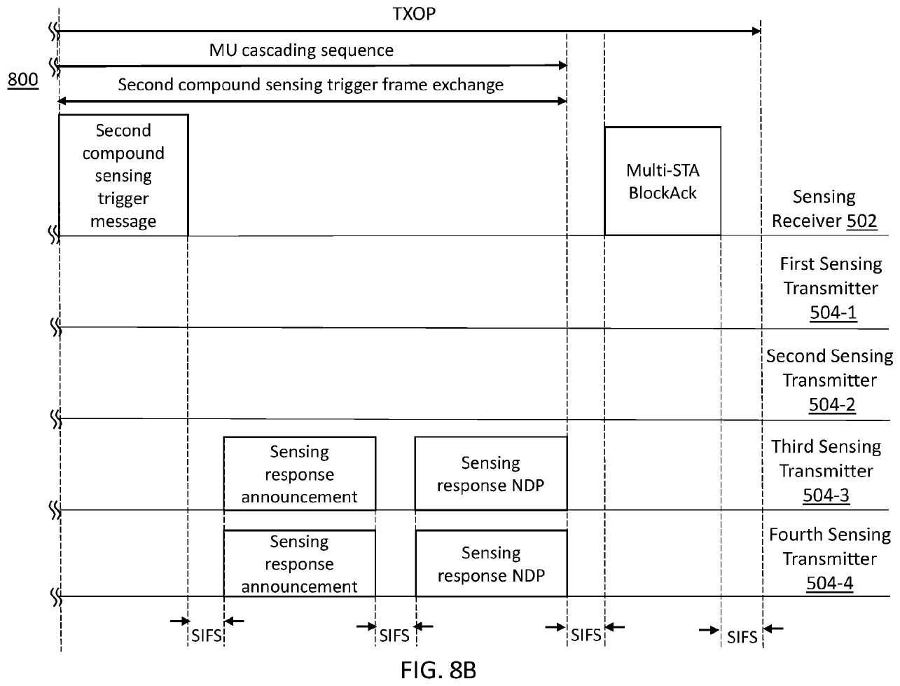

FIGS. 8A and 8B depicts exemplary MU cascading sequence sensing transmission transaction 800, according to some embodiments.

In the example shown in FIGS. 8A and 8B, sensing receiver 502 transmits a first compound sensing trigger message to trigger sensing transmissions from first sensing transmitter 504-1 and second sensing transmitter 504-2. Further, sensing receiver 502 transmits a second compound sensing trigger message to trigger sensing transmissions from third sensing transmitter 504-3 and fourth sensing transmitter 504-4. As described in FIGS. 8A and 8B, the second compound sensing trigger message is transmitted within a same TXOP as the first compound sensing trigger message. In response to the first compound sensing trigger message, each of first sensing transmitter 504-1 and second sensing transmitter 504-2 respond, after a period of one SIFS, with a sensing response announcement followed after one further SIFS by a sensing response NDP. Further, in response to the second compound sensing trigger message, third sensing transmitter 504-3 and fourth sensing transmitter 504-4 respond, after a period of one SIFS, with a sensing response announcement followed after one further SIFS by a sensing response NDP.

Referring back to FIG. 5, in an implementation, sensing receiver 502 may receive, via receiving antenna 514, the one or more sensing transmissions from each of the one or more sensing transmitters transmitted in response to the compound sensing trigger message. In an implementation, after the one or more sensing transmissions are completed, sensing receiver 502 may send a Multi-STA BlockAck to corresponding sensing transmitters. According to an implementation, upon receiving the one or more sensing transmissions, sensing agent 516 may generate a sensing measurement based on each of the one or more sensing transmissions.

According to an implementation, if sensing agent 516 receives one or more sensing response announcements from the one or more sensing transmitters, then sensing agent 516 may not perform a sensing measurement on the one or more sensing response announcements and instead process the content of the sensing response announcements to determine the delivered transmission configurations of the corresponding sensing response NDPs that will be transmitted after the next SIFS. Sensing agent 516 then receives the sensing response NDPs and performs sensing measurements. In situations where a sensing response announcement is not created, sensing receiver 502 may assume that the delivered transmission configuration of the subsequent sensing response NDP is the same as the requested transmission configuration and steering matrix configuration of the received compound sensing trigger message.

According to some implementations, sensing agent 516 may give preference to a sensing response announcement and a sensing response NDP over a sensing response message even where the sensing response message may be supported. This may allow all sensing transmissions on which sensing measurements are made to be sensing response NDP and all sensing response NDP to be received by sensing receiver 502 in the same PPDU (i.e., all triggered sensing transmissions are transmitted and received at the same time). In this example, the de-livered transmission configuration and steering matrix configuration in the sensing response announcement may reflect the configuration used to deliver the subsequent sensing response NDP and may also correspond to the configuration used to deliver the sensing response announcement.

In an implementation, the compound sensing trigger message may include a request that the one or more sensing transmitters respond with time-synchronized sensing transmissions, where the one or more sensing transmissions may be a combination of sensing response messages and sensing response NDP. The one or more sensing transmissions from the one or more sensing transmitters may be synchronized by transmitting either one of A, B, and C:
A. A sensing response announcement followed by sensing response NDP (for example, in the case where the requested transmission configuration and/or sensing matrix configuration cannot support the transfer of data)
B. A padding or no transmission, configured to have a duration equal to that of a sensing response announcement that is received from the one or more sensing transmitters that are responding in this manner, followed by a sensing response message (for example, in the case where the requested transmission configuration and/or sensing matrix configuration can support the transfer of data).
C. A sensing response NDP without an initial sensing response announcement (delivered with the requested transmission configuration and sensing matrix configuration provided by the compound sensing trigger message).

According to an example implementation, the padding of B above, from one or more sensing transmitters may be combined using UL-OFDMA with sensing response announcement from one or more other sensing transmitters and when the padding is received by sensing receiver 502, sensing receiver 502 may not perform any action other than to wait for a valid response to the compound sensing trigger message from the sensing transmitter. In an example implementation, sensing response NDP from one or more sensing transmitters and sensing response messages from one or more other sensing transmitters may be combined using UL-OFDMA following one SIFS, ensuring that all sensing transmissions are received in the same PPDU. In some implementations, a second padding may be used to ensure that all sensing trans-missions are the same length and may be supported by UL-OFDMA.

In an implementation, sensing receiver 502 may receive two transmissions transmitted by first sensing transmitter 504-1. In an example, the first sensing transmission may include a sensing response announcement and at least one data packet, and the second sensing transmission may include a sensing response NDP. According to an example, the sensing response announcement may include an indication that the sensing response NDP having a delivered transmission configuration corresponding to a requested transmission configuration will be transmitted after approximately one SIFS. According to an implementation, sensing agent 516 may process the sensing response announcement to determine an expected delivered transmission configuration of the sensing response NDP corresponding to the requested transmission configuration. In an implementation, sensing agent 516 may generate a sensing measurement on the sensing response NDP. In some implementations, sensing agent 516 may receive a single sensing transmission transmitted by second sensing transmitter 504-2. In an example, the single sensing transmission may include a sensing response message having a delivered transmission configuration corresponding to the requested transmission configuration including at least one data packet.

According to an implementation, subsequent to generating the sensing measurements based on the sensing transmissions, sensing agent 516 may obtain an identification of a feature of interest according to the sensing measurements. In an implementation, sensing agent 516 may identify the feature of interest according to the sensing measurements. In some implementations, sensing agent 516 may transmit the sensing measurements to remote processing device 506. On receiving the sensing measurements, remote processing device 506 may execute a sensing algorithm to identify the feature of interest. Further, remote processing device 506 may transmit the identification of the feature of interest to sensing receiver 502.

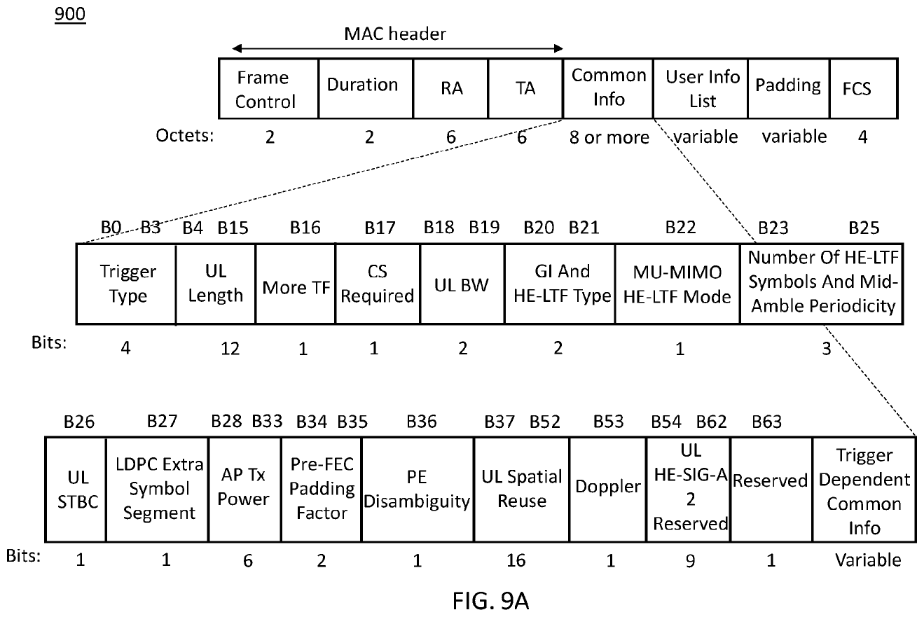

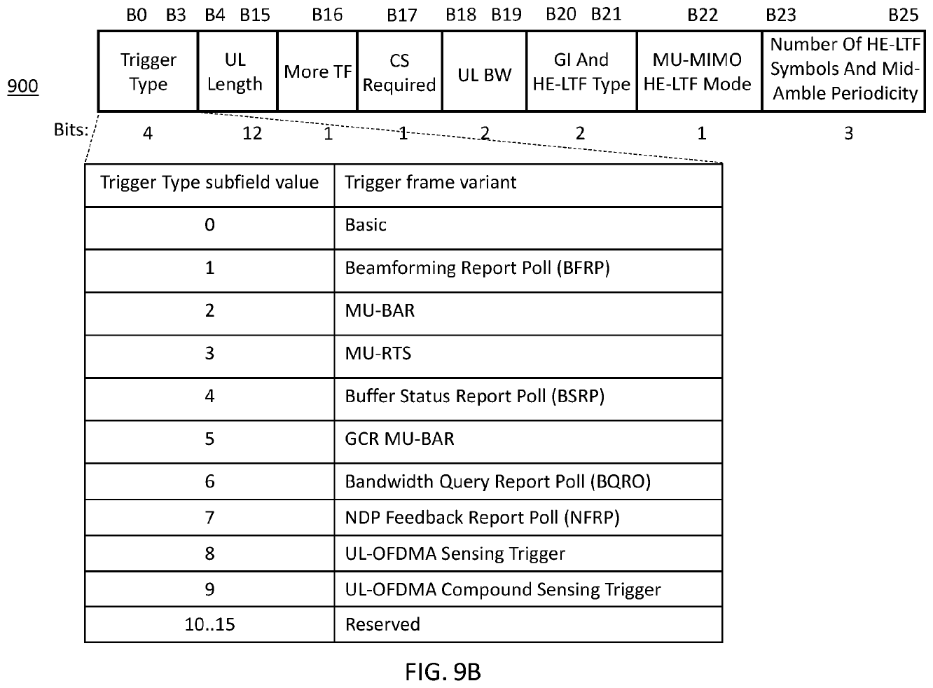

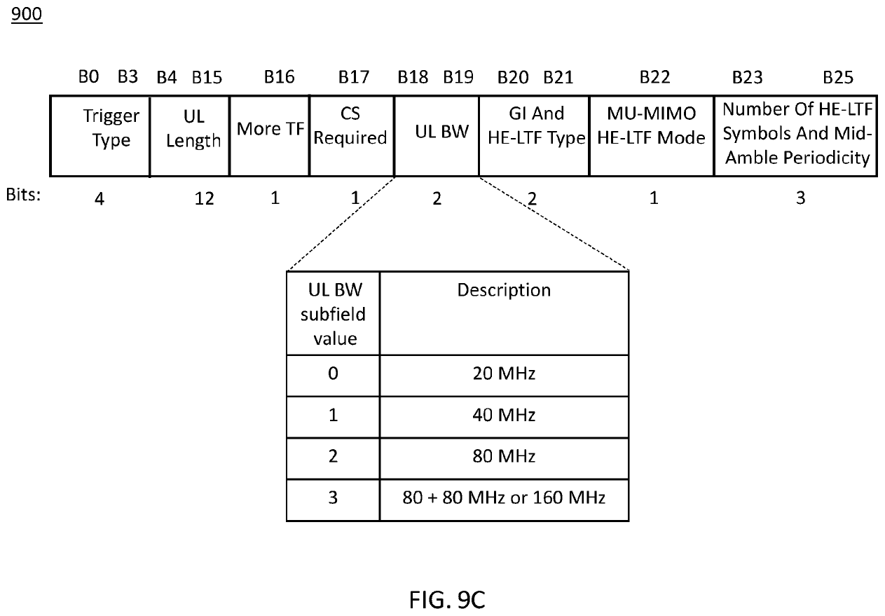

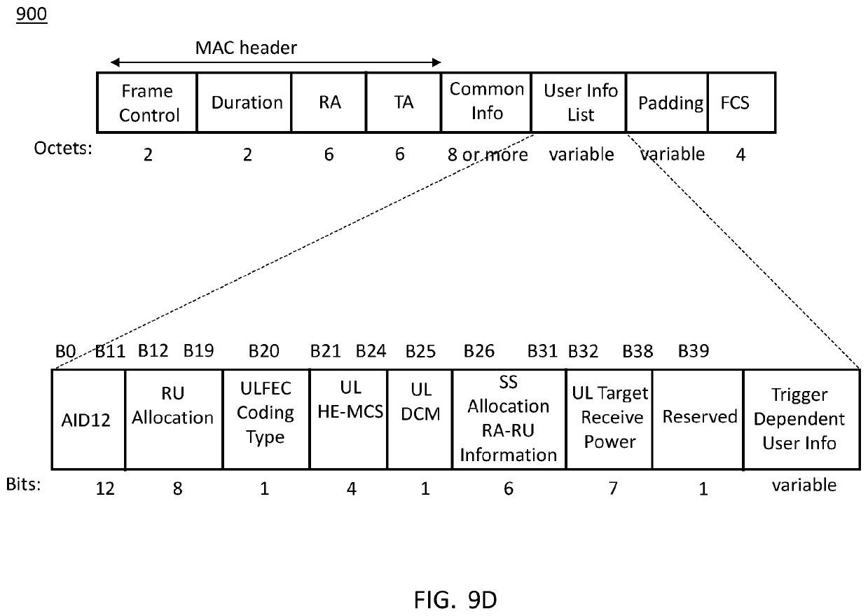

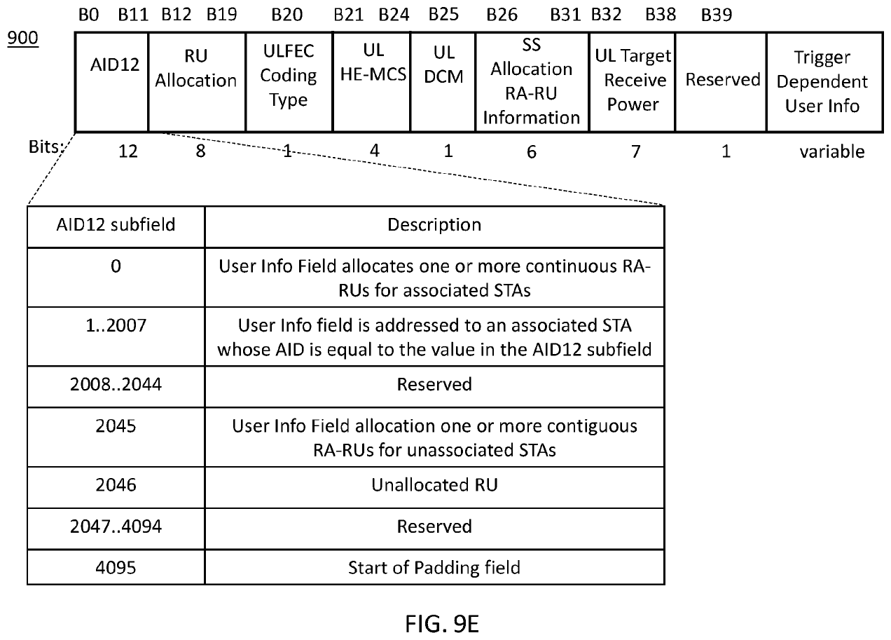

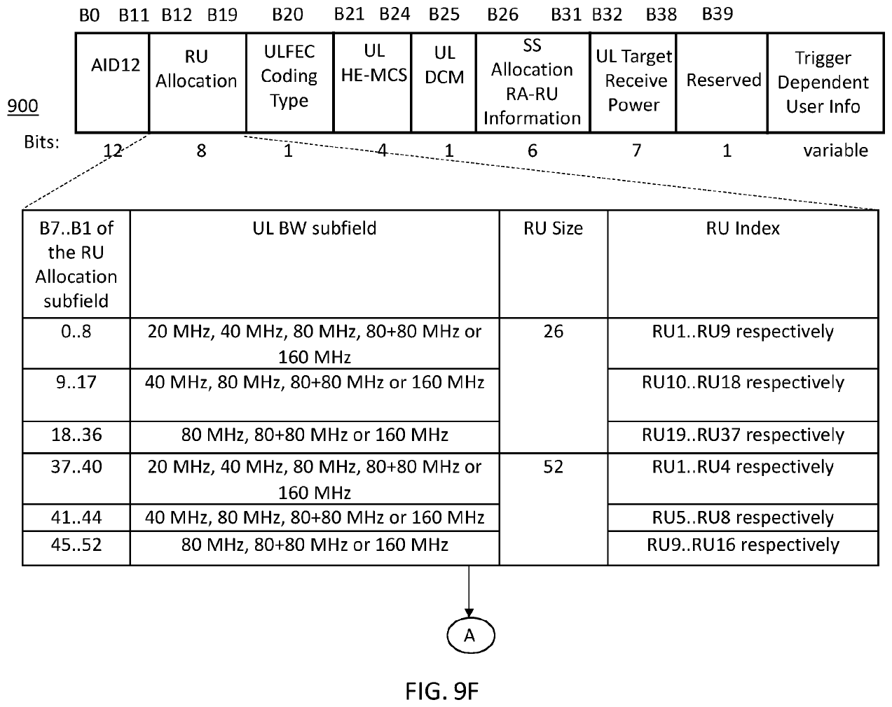

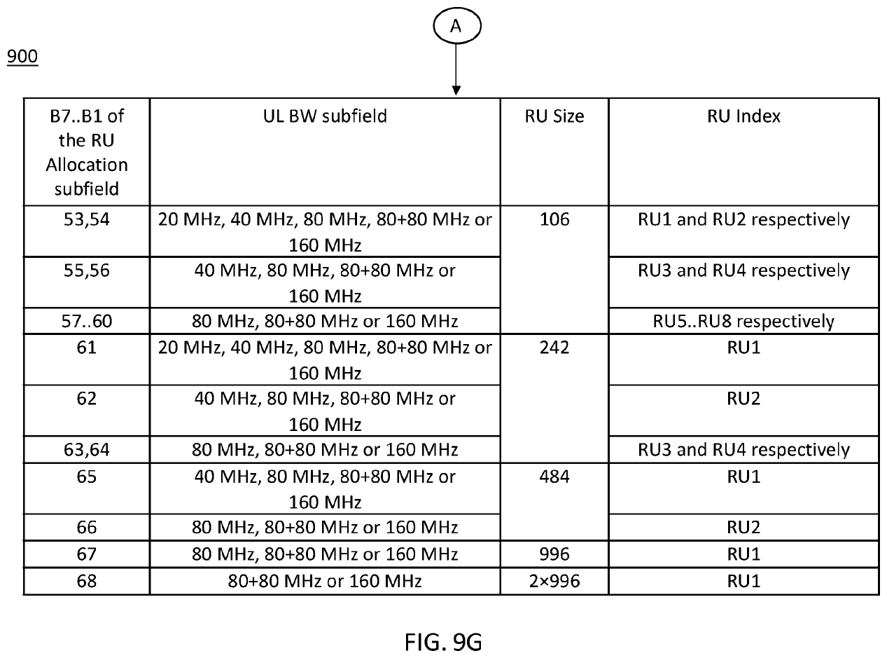

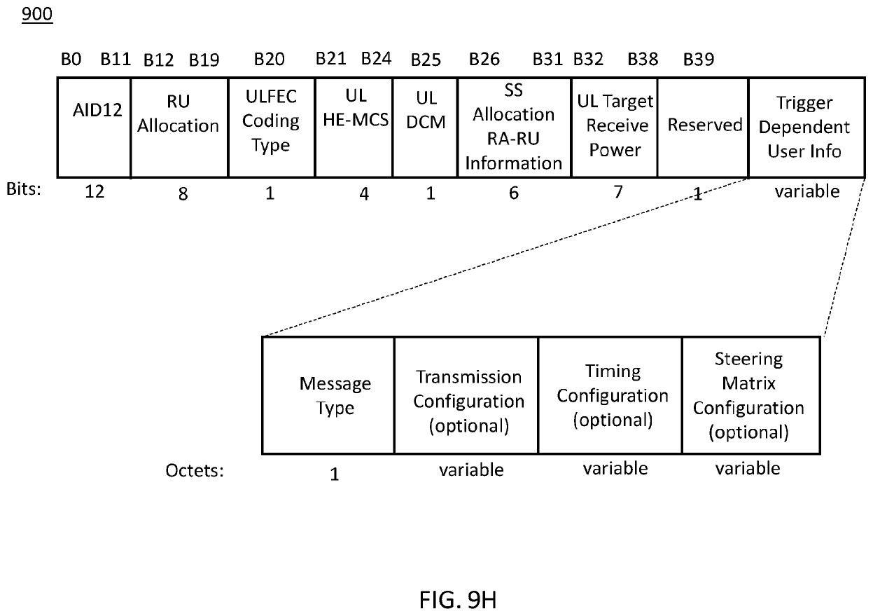

According to an implementation, example 900 of a hierarchy of fields within compound sensing trigger message (or UL-OFDMA compound sensing trigger) is shown in FIGS. 9A to 9H.

As described in FIG. 9A, the Common Info field contains information which is common to the plurality of sensing transmitters 504-(1-M).

As described in FIG. 9B, a new Trigger Type (within B0 . . . 3 of “Common Info” field) may be defined which represents the compound sensing trigger message (or UL-OFDMA compound sensing trigger). The compound sensing trigger message (or UL-OFDMA compound sensing trigger) may have a Triger Type subfield value of 9. In an example of triggering a sensing transmission from a sensing transmitter, “Trigger Dependent User Info” field may include sensing trigger message data. In an implementation, a time-synchronized sensing transmission may be required from all sensing transmitters responding to the compound sensing trigger message. In an example, the requirement for time-synchronized sensing transmission may be encoded into “Trigger Dependent Common Info” field. According to an example, the requirement may be encoded by a single bit where 0 (bit clear) represents a request for a normal or non-time-synchronized response and 1 (bit set) represents a request for a time-synchronized response. In some examples, a method of time-synchronization may be requested in the UL-OFDMA compound sensing trigger. In examples, the method of time-synchronization to be requested may be encoded into “Trigger Dependent Common Info” field. In examples the encoding may use two bits as shown in the following table.

| Encoding | Method | Description |
|---|---|---|
| 00 | A | Sensing response announcement followed by |
| | | sensing response NDP. |
| 01 | B | Padding followed by a sensing response message. |
| 10 | C | Sensing response NDP without an initial sensing |
| | | response announcement. |
| 11 | N/A | For future use or extensions. |

As described in FIG. 9C the compound sensing trigger message may have an uplink bandwidth (UL BW) subfield value of 0, 1, 2 or 4 corresponding to bandwidths of 20 MHz, 40 MHz, 80 MHz, or 80+80 MHz (160 MHz).

As described in FIG. 9D, the User Info List contains information which is specific to each of the plurality of sensing transmitters 504-(1-M).

As described in FIG. 9E, the AID12 subfield may be used to address a specific sensing transmitter of the plurality of sensing transmitters 504-(1-M).

As described in FIG. 9F and FIG. 9G, the RU Allocation subfield is used to allocate resource units (RU) to each of the plurality of sensing transmitters 504-(1-M).

As described in FIG. 9F, the Trigger Dependent User Info subfield may be used to request the transmission configuration and/or steering matrix configuration for each of the plurality of sensing transmitters 504-(1-M) that the compound sensing trigger message is triggering.

According to some implementations, the requirement of a sensing response announcement preceding a sensing response NDP may be optional. This may be indicated to sensing transmitters 504-(1-M) and may be encoded into the “Trigger Dependent Common Info” field if the requirement is common to all responding sensing transmitters, or into the “Trigger Dependent User Info” field if requirement is specific to one or more responding sensing transmitters. According to an example, the requirement for a sensing announcement preceding a sensing response NDP may be encoded by a single bit where 0 (bit clear) indicates that a sensing announcement is optional and 1 (bit set) indicates that a sensing announcement is required.

In some implementations, the compound sensing trigger message may describe a super-set of functionality over an UL-OFDMA sensing trigger. In some examples, the Trigger type of an UL-OFDMA sensing trigger (i.e., 8) may be reused for a compound sensing trigger message. The requirement to trigger a compound response may be encoded into another part of the UL-OFDMA sensing trigger. In an example, in the “Trigger Dependent Common Info” field, a single bit may encode normal response (bit clear) or compound response (bit set).

FIG. 10 depicts flowchart 1000 for generating sensing measurements by sensing receiver 502 based on sensing transmissions, according to some embodiments.

In a brief overview of an implementation of flowchart 1000, at step 1002, a compound sensing trigger message is generated. At step 1004, the compound sensing trigger message is transmitted to a sensing transmitter. At step 1006, a sensing response announcement transmitted by the sensing transmitter is received. At step 1008, a sensing response NDP transmitted by the sensing transmitter is received. At step 1010, a sensing measurement is generated based on the sensing response NDP.

Step 1002 includes generating a compound sensing trigger message. According to an implementation, sensing receiver 502 may generate the compound sensing trigger message. In an implementation, the compound sensing trigger message may include an indication for one or more sensing transmitters that a response may include two transmissions, the two transmissions including the sensing response announcement and the sensing response NDP. Also, the compound sensing trigger message may include a requested transmission configuration. In some implementations, the compound sensing trigger message may include an indication for one or more sensing transmitters that a response may include two transmissions if the requested transmission configuration is incompatible with accurate demodulation of data in a sensing transmission.

Step 1004 includes transmitting the compound sensing trigger message to a sensing transmitter. According to an implementation, sensing receiver 502 may transmit the compound sensing trigger message to the sensing transmitter. In an example, the sensing transmitter may be first sensing transmitter 504-1. In some examples, the sensing transmitter may be second sensing transmitter 504-2.

Step 1006 includes receiving a sensing response announcement transmitted by the sensing transmitter. According to an implementation, sensing receiver 502 may receive the sensing response announcement transmitted by the sensing transmitter. In an example, receiving the sensing response announcement may include receiving the sensing transmission that includes the sensing response announcement and at least one data packet. In an implementation, the sensing response announcement may include an indication that a sensing response NDP having a delivered transmission configuration corresponding to the requested transmission configuration will be transmitted after approximately one short interframe space.

Step 1008 includes receiving a sensing response NDP transmitted by the sensing transmitter. According to an implementation, sensing receiver 502 may receive the sensing response NDP transmitted by the sensing transmitter. In an implementation, sensing receiver 502 may receiving the sensing response NDP approximately one short interframe space after receiving the sensing response announcement.

Step 1010 includes generating a sensing measurement based on the sensing response NDP. According to an implementation, sensing receiver 502 may generate the sensing measurement based on the sensing response NDP. Sensing receiver 502 may process the sensing response announcement to determine an expected delivered transmission configuration of the sensing response NDP corresponding to the requested transmission configuration. Also, sensing receiver 502 may transmit a transmits a Multi-STA BlockAck to the sensing transmitter responsive to generating the sensing measurement.

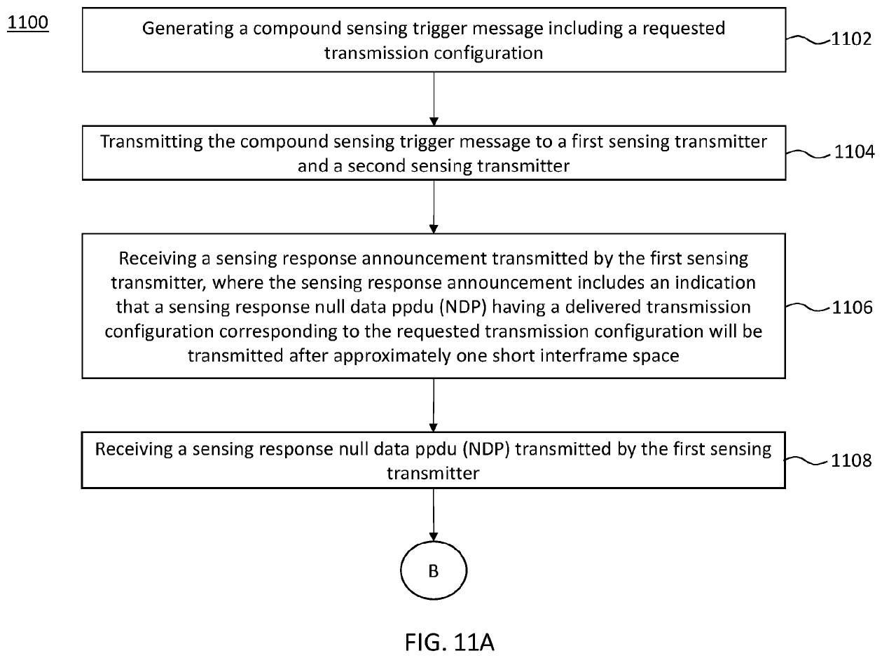

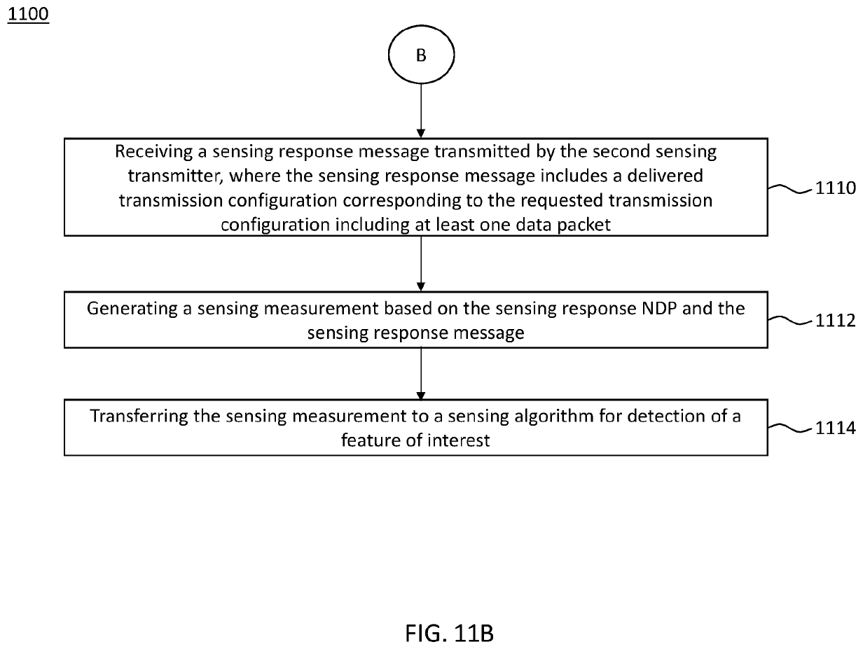

FIGS. 11A and 11B depict flowchart 1100 for transferring sensing measurements to remote processing device 506 for detection of a feature of interest, according to some embodiments.

In a brief overview of an implementation of flowchart 1100, at step 1102, a compound sensing trigger message including a requested transmission configuration is generated. At step 1104, the compound sensing trigger message is transmitted to first sensing transmitter 504-1 and second sensing transmitter 504-2. At step 1106, a sensing response announcement transmitted by first sensing transmitter 504-1 is received. The sensing response announcement includes an indication that a sensing response NDP having a delivered transmission configuration corresponding to the requested transmission configuration will be transmitted after approximately one short interframe space. At step 1108, a sensing response NDP transmitted by first sensing transmitter 504-1 is received. At step 1110, a sensing response message transmitted by second sensing transmitter 504-2 is received. The sensing response message includes a delivered transmission configuration corresponding to the requested transmission configuration including at least one data packet. At step 1112, a sensing measurement is generated based on the sensing response NDP and the sensing response message. At step 1114, the sensing measurement is transferred to remote processing device 506 for detection of a feature of interest.

Step 1102 includes generating a compound sensing trigger message including a requested transmission configuration. According to an implementation, sensing receiver 502 may generate the compound sensing trigger message including the requested transmission configuration.

Step 1104 includes transmitting the compound sensing trigger message to first sensing transmitter 504-1 and second sensing transmitter 504-2. According to an implementation, sensing receiver 502 may transmit the compound sensing trigger message to first sensing transmitter 504-1 and second sensing transmitter 504-2.

Step 1106 includes receiving a sensing response announcement transmitted by first sensing transmitter 504-1, where the sensing response announcement includes an indication that a sensing response NDP having a delivered transmission configuration corresponding to the requested transmission configuration will be transmitted after approximately one short interframe space. According to an implementation, sensing receiver 502 may receive the sensing response announcement transmitted by first sensing transmitter 504-1, where the sensing response announcement includes the indication that the sensing response NDP having the delivered transmission configuration corresponding to the requested transmission configuration will be transmitted after approximately one short interframe space.

Step 1108 includes receiving a sensing response NDP transmitted by first sensing transmitter 504-1. According to an implementation, sensing receiver 502 may receive the sensing response NDP transmitted by first sensing transmitter 504-1.

Step 1110 includes receiving a sensing response message transmitted by second sensing transmitter 504-2, where the sensing response message includes a delivered transmission configuration corresponding to the requested transmission configuration including at least one data packet. According to an implementation, sensing receiver 502 may receive the sensing response message transmitted by second sensing transmitter 504-2, where the sensing response message includes the delivered transmission configuration corresponding to the requested transmission configuration including at least one data packet.

Step 1112 includes generating a sensing measurement based on the sensing response NDP and the sensing response message. According to an implementation, sensing receiver 502 may generate the sensing measurement based on the sensing response NDP and the sensing response message.

Step 1114 includes transferring the sensing measurement to remote processing device 506 for detection of a feature of interest. According to an implementation, sensing receiver 502 may transfer the sensing measurement to remote processing device 506 comprising a sensing algorithm for detection of the feature of interest.

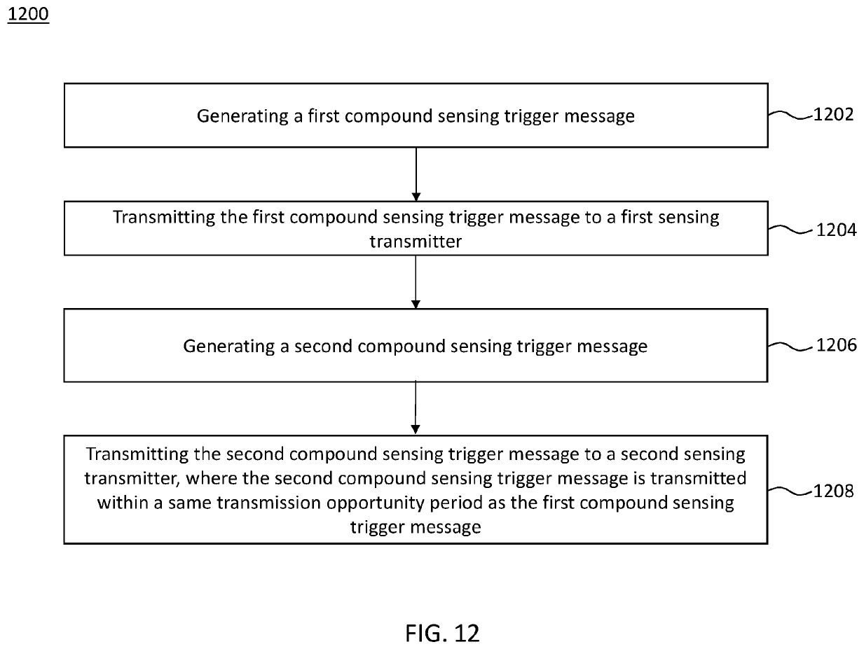

FIG. 12 depicts flowchart 1200 for generating a first compound sensing trigger message and a second compound sensing trigger message by sensing receiver 502, according to some embodiments.

In a brief overview of an implementation of flowchart 1200, at step 1202, a first compound sensing trigger message is generated. At step 1204, the first compound sensing trigger message is transmitted to first sensing transmitter 504-1. At step 1206, a second compound sensing trigger message is generated. At step 1208, the second compound sensing trigger message is transmitted to second sensing transmitter 504-2. The second compound sensing trigger message is transmitted within a same transmission opportunity period as the first compound sensing trigger message.

Step 1202 includes generating a first compound sensing trigger message. According to an implementation, sensing receiver 502 may generate the first compound sensing trigger message.

Step 1204 includes transmitting the first compound sensing trigger message to first sensing transmitter 504-1. According to an implementation, sensing receiver 502 may transmit the first compound sensing trigger message to first sensing transmitter 504-1.

Step 1206 includes generating a second compound sensing trigger message. According to an implementation, sensing receiver 502 may generate the second compound sensing trigger message.

Step 1208 includes transmitting the second compound sensing trigger message to second sensing transmitter 504-1. The second compound sensing trigger message is transmitted within a same transmission opportunity period as the first compound sensing trigger message. According to an implementation, sensing receiver 502 may transmit the second compound sensing trigger message to second sensing transmitter 504-1.

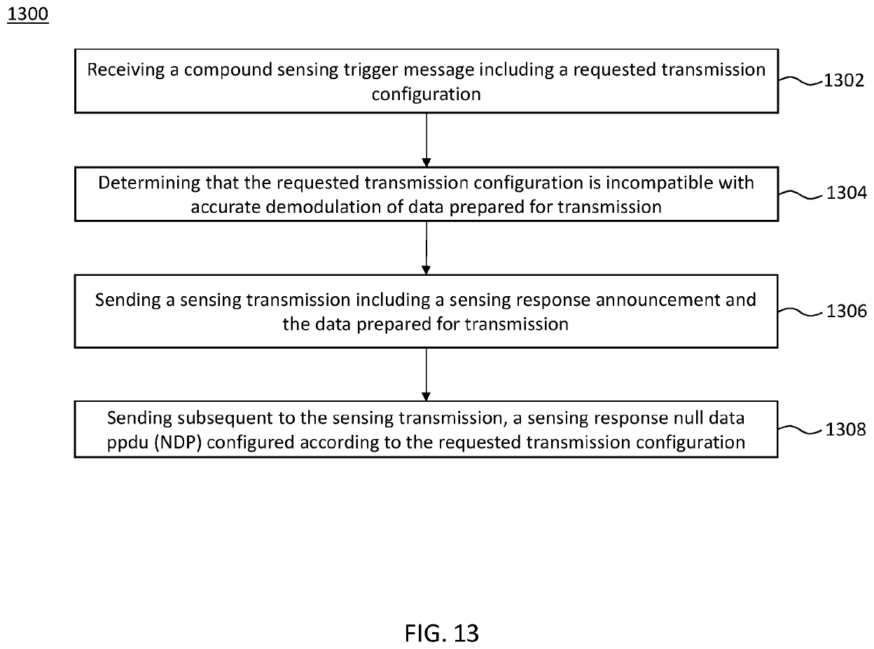

FIG. 13 depicts flowchart 1300 for sending a sensing transmission to sensing receiver 502, according to some embodiments.

In a brief overview of an implementation of flowchart 1300, at step 1302, a compound sensing trigger message including a requested transmission configuration is received. At step 1304, it is determined that the requested transmission configuration is incompatible with accurate demodulation of data prepared for transmission. At step 1306, a sensing transmission including a sensing response announcement and the data prepared for transmission is sent. At step 1308, subsequent to the sensing transmission, a sensing response NDP configured according to the requested transmission configuration is sent.

Step 1302 includes receiving a compound sensing trigger message including a requested transmission configuration. According to an implementation, a sensing transmitter (for example, first sensing transmitter 504-1) may receive the compound sensing trigger message including the requested transmission configuration.

Step 1304 includes determining that the requested transmission configuration is incompatible with accurate demodulation of data prepared for transmission. According to an implementation, the sensing transmitter may determine that the requested transmission configuration is incompatible with accurate demodulation of data prepared for transmission.

Step 1306 includes sending a sensing transmission including a sensing response announcement and the data prepared for transmission. According to an implementation, the sensing transmitter may send the sensing transmission including the sensing response announcement and the data prepared for transmission to sensing receiver 502. In an example, the sensing response announcement includes an indication that the sensing response NDP will be transmitted after approximately one short interframe space.

Step 1308 includes sending subsequent to the sensing transmission, a sensing response NDP configured according to the requested transmission configuration. According to an implementation, the sensing transmitter may send subsequent to the sensing transmission, the sensing response NDP configured according to the requested transmission configuration to sensing receiver 502. In an example, sending the sensing response NDP is performed approximately one short interframe space after sending the sensing transmission.

Embodiment 1 is a method for Wi-Fi sensing carried out by a sensing receiver including a transmitting antenna, a receiving antenna, and at least one processor configured to execute instructions, the method comprising: generating, by the at least one processor, a compound sensing trigger message; transmitting, by the transmitting antenna, the compound sensing trigger message; receiving, via the receiving antenna, a sensing response announcement transmitted by a sensing transmitter; receiving, via the receiving antenna, a sensing response null data PPDU (NDP); and generating, by the at least one processor, a sensing measurement on the sensing response NDP.

Embodiment 2 is the method of embodiment 1, wherein the compound sensing trigger message includes an indication for one or more sensing transmitters that a response may include two transmissions, the two transmissions including the sensing response announcement and the sensing response NDP.

Embodiment 3 is the method of embodiment 1 or 2, wherein the compound sensing trigger message includes a requested transmission configuration.

Embodiment 4 is the method of embodiment 3, wherein the compound sensing trigger message includes an indication for one or more sensing transmitters that a response may include two transmissions if the requested transmission configuration is incompatible with accurate demodulation of data in a sensing transmission.

Embodiment 5 is the method of any of embodiments 1-4, wherein the sensing transmitter is a first sensing transmitter, the method further comprising: receiving, via the receiving antenna and from a second sensing transmitter, a sensing response message having a delivered transmission configuration corresponding to a requesting transmission configuration comprising at least one data packet.

Embodiment 6 is the method of any of embodiments 1-5, further comprising receiving the sensing response NDP approximately one short interframe space after receiving the sensing response announcement.

Embodiment 7 is the method of any of embodiments 1-6, wherein the sensing response announcement includes an indication that the sensing response NDP having a delivered transmission configuration corresponding to a requested transmission configuration will be transmitted after approximately one short interframe space.

Embodiment 8 is the method of any of embodiments 1-7, wherein receiving the sensing response announcement includes receiving a sensing transmission that contains the sensing response announcement and at least one data packet.

Embodiment 9 is the method of any of embodiments 1-8, further comprising transferring the sensing measurement to a sensing algorithm for detection of a feature of interest.

Embodiment 10 is the method of any of embodiments 1-9, further comprising processing the sensing response announcement to determine an expected delivered transmission configuration of the sensing response NDP corresponding to a requested transmission configuration.

Embodiment 11 is the method of any of embodiments 1-10, further comprising transmitting, by the transmitting antenna and responsive to generating the sensing measurement, a Multi-Sta BlockAck.

Embodiment 12 is the method of any of embodiments 1-11, wherein the compound sensing trigger message is a first compound sensing trigger message, the method further comprising: generating, by the at least one processor, a second compound sensing trigger message; and transmitting, by the transmitting antenna, the second compound sensing trigger message within a same transmission opportunity period as the first compound sensing trigger message.

Embodiment 13 is a method for Wi-Fi sensing carried out by a sensing transmitter including a receiving antenna, a transmitting antenna, and at least one processor configured to execute instructions, the method comprising: receiving, via the receiving antenna, a compound sensing trigger message including a requested transmission configuration; determining, by the at least one processor, that the requested transmission configuration is incompatible with accurate demodulation of data prepared for transmission; sending, by the transmitting antenna, a sensing transmission including a sensing response announcement and the data prepared for transmission; and sending, by the transmitting antenna, subsequent to the sensing transmission, a sensing response NDP configured according to the requested transmission configuration.

Embodiment 14 is the method of embodiment 13, wherein the sensing response announcement includes an indication that the sensing response NDP will be transmitted after approximately one short interframe space.

Embodiment 15 is the method of embodiment 13 or 14, wherein sending the sensing response NDP is performed approximately one short interframe space after sending the sensing transmission.

Embodiment 16 is a system for Wi-Fi sensing, the system comprising: a sensing receiver including a transmitting antenna, a receiving antenna, and at least one processor configured to execute instructions for: generating, by the at least one processor, a compound sensing trigger message; transmitting, by the transmitting antenna, the compound sensing trigger message; receiving, via the receiving antenna, a sensing response announcement transmitted by a sensing transmitter; receiving via the receiving antenna, a sensing response null data PPDU (NDP); and generating, by the at least one processor, a sensing measurement on the sensing response NDP.

Embodiment 17 is the system of embodiment 16, wherein the compound sensing trigger message includes an indication for one or more sensing transmitters that a response may include two transmissions, the two transmissions including the sensing response announcement and the sensing response NDP.

Embodiment 18 is the system of embodiment 16 or 17, wherein the compound sensing trigger message includes a requested transmission configuration.

Embodiment 19 is the system of embodiment 18, wherein the compound sensing trigger message includes an indication for one or more sensing transmitters that a response may include two transmissions if the requested transmission configuration is incompatible with accurate demodulation of data in a sensing transmission.

Embodiment 20 is the system of any of embodiments 16-20, wherein the sensing transmitter is a first sensing transmitter, the processor being further configured to execute instructions for: receiving, via the receiving antenna and from a second sensing transmitter, a sensing response message having a delivered transmission configuration corresponding to a requested transmission configuration comprising at least one data packet.

Embodiment 21 is the system of any of embodiments 16-20, the processor being further configured to execute instructions for receiving the sensing response NDP approximately one short interframe space after receiving the sensing response announcement.

Embodiment 22 is the system of any of embodiments 16-21, herein the sensing response announcement includes an indication that the sensing response NDP having a delivered transmission configuration corresponding to a requested transmission configuration will be transmitted after approximately one short interframe space.

Embodiment 23 is the system of any of embodiments 16-22, wherein receiving the sensing response announcement includes receiving a sensing transmission that contains the sensing response announcement and at least one data packet.

Embodiment 24 is the system of any of embodiments 16-24, the processor being further configured to execute instructions for transferring the sensing measurement to a sensing algorithm for detection of a feature of interest.

Embodiment 25 is the system of any of embodiments 18-24, the processor being further configured to execute instructions for processing the sensing response announcement to determine an expected delivered transmission configuration of the sensing response NDP corresponding to the requested transmission configuration.

Embodiment 26 is the system of any of embodiments 16-25, the processor being further configured to execute instructions for transmitting, by the transmitting antenna and responsive to generating the sensing measurement, a Multi-Sta BlockAck.

Embodiment 27 is the system of any of embodiments 16-26, wherein the compound sensing trigger message is a first compound sensing trigger message, the processor being further configured to execute instructions for: generating, by the at least one processor, a second compound sensing trigger message; and transmitting, by the transmitting antenna, the second compound sensing trigger message within a same transmission opportunity period as the first compound sensing trigger message.

Embodiment 28 a system for Wi-Fi sensing comprising a sensing transmitter including a receiving antenna, a transmitting antenna, and at least one processor configured to execute instructions for: receiving, via the receiving antenna, a compound sensing trigger message including a requested transmission configuration; determining, by the at least one processor, that the requested transmission configuration is incompatible with accurate demodulation of data prepared for transmission; sending, by the transmitting antenna, a sensing transmission including a sensing response announcement and the data prepared for transmission; and sending, by the transmitting antenna, subsequent to the sensing transmission, a sensing response NDP configured according to the requested transmission configuration.

Embodiment 29 is the system of embodiment 28, wherein the sensing response announcement includes an indication that the sensing response NDP will be transmitted after approximately one short interframe space.

Embodiment 30 is the system of embodiment 28 or 29, wherein sending the sensing response NDP is performed approximately one short interframe space after sending the sensing transmission.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a sensing initiator including a transmitting antenna, a receiving antenna, and at least one processor configured to execute instructions, the method comprising:
generating, by the at least one processor, a compound sensing trigger message;
transmitting, by the transmitting antenna, the compound sensing trigger message;
receiving, via the receiving antenna, a sensing response announcement transmitted by a sensing responder;
receiving, via the receiving antenna, a sensing response null data PPDU (NDP); and generating, by the at least one processor, a sensing measurement on the sensing response NDP.

2. The method of claim 1, wherein the compound sensing trigger message includes an indication for one or more sensing responders that a response may include two transmissions, the two transmissions including the sensing response announcement and the sensing response NDP.

3. The method of claim 1, wherein the compound sensing trigger message includes a requested transmission configuration.

4. The method of claim 3, wherein the compound sensing trigger message includes an indication for one or more sensing responders that a response may include two transmissions if the requested transmission configuration is incompatible with accurate demodulation of data in a sensing transmission.

5. The method of claim 3, wherein the sensing responder is a first sensing responder, the method further comprising:
receiving, via the receiving antenna and from a second sensing responder, a sensing response message having a delivered transmission configuration corresponding to the requested transmission configuration, wherein the sensing response message comprises at least one data packet.

6. The method of claim 1, further comprising receiving the sensing response NDP approximately one short interframe space after receiving the sensing response announcement.

7. (canceled)

8. The method of claim 1, wherein receiving the sensing response announcement includes receiving a sensing transmission that contains the sensing response announcement and at least one data packet.

9. (canceled)

10. The method of claim 3, further comprising processing the sensing response announcement to determine an expected delivered transmission configuration of the sensing response NDP corresponding to a requested transmission configuration.

11. The method of claim 1, further comprising transmitting, by the transmitting antenna and responsive to generating the sensing measurement, a Multi-Sta BlockAck.

12. The method of claim 1, wherein the compound sensing trigger message is a first compound sensing trigger message, the method further comprising:
generating, by the at least one processor, a second compound sensing trigger message; and
transmitting, by the transmitting antenna, the second compound sensing trigger message within a same transmission opportunity period as the first compound sensing trigger message.

13-15. (canceled)

16. A system for Wi-Fi sensing, the system comprising:
a sensing initiator including a transmitting antenna, a receiving antenna, and at least one processor configured to execute instructions for:
generating, by the at least one processor, a compound sensing trigger message;
transmitting, by the transmitting antenna, the compound sensing trigger message;
receiving, via the receiving antenna, a sensing response announcement transmitted by a sensing responder;
receiving, via the receiving antenna, a sensing response null data PPDU (NDP); and
generating, by the at least one processor, a sensing measurement on the sensing response NDP.

17. The system of claim 16, wherein the compound sensing trigger message includes an indication for one or more sensing responders that a response may include two transmissions, the two transmissions including the sensing response announcement and the sensing response NDP.

18. The system of claim 16, wherein the compound sensing trigger message includes a requested transmission configuration.

19. The system of claim 18, wherein the compound sensing trigger message includes an indication for one or more sensing responders that a response may include two transmissions if the requested transmission configuration is incompatible with accurate demodulation of data in a sensing transmission.

20. The system of claim 18, wherein the sensing responder is a first sensing responder, the processor being further configured to execute instructions for:
receiving, via the receiving antenna and from a second sensing responder, a sensing response message having a delivered transmission configuration corresponding to the requested transmission configuration, wherein the sensing response message comprises at least one data packet.

21. The system of claim 16, the processor being further configured to execute instructions for receiving the sensing response NDP approximately one short interframe space after receiving the sensing response announcement.

22. (canceled)

23. The system of claim 16, wherein receiving the sensing response announcement includes receiving a sensing transmission that contains the sensing response announcement and at least one data packet.

24. (canceled)

25. The system of claim 18, the processor being further configured to execute instructions for processing the sensing response announcement to determine an expected delivered transmission configuration of the sensing response NDP corresponding to the requested transmission configuration.

26. The system of claim 16, the processor being further configured to execute instructions for transmitting, by the transmitting antenna and responsive to generating the sensing measurement, a Multi-Sta BlockAck.

27. The system of claim 16, wherein the compound sensing trigger message is a first compound sensing trigger message, the processor being further configured to execute instructions for:
generating, by the at least one processor, a second compound sensing trigger message; and
transmitting, by the transmitting antenna, the second compound sensing trigger message within a same transmission opportunity period as the first compound sensing trigger message.

28-30. (canceled)
